(19) United States
(12) Patent Application Publication
(10) Pub. No.: US 2019/0130583 A1
(43) Pub. Date: May 2, 2019

(54) STILL AND SLOW OBJECT TRACKING IN A HYBRID VIDEO ANALYTICS SYSTEM

(71) Applicant: QUALCOMM Incorporated, San Diego, CA (US)

(72) Inventors: Ying CHEN, San Diego, CA (US); Yang ZHOU, San Jose, CA (US); Karthik NAGARAJAN, Cupertino, CA (US)

(21) Appl. No.: 16/172,540

(22) Filed: Oct. 26, 2018

Related U.S. Application Data
(60) Provisional application No. 62/578,926, filed on Oct. 30, 2017.

(51) Int. Cl. G06T 7/20; G06K 9/00; G06T 7/11; G06T 7/194

(52) U.S. Cl. CPC G06T 7/20; G06K 9/00503; G06T 2207/20224; G06T 7/194; G06T 7/11

(57) ABSTRACT

Techniques and systems are provided for tracking objects in a sequence of video frames. For example, an object tracker maintained for the sequence of video frames is identified. An object tracked by the object tracker is detected based on an application of an object detector to at least one key frame in the sequence of video frames. The object detector can include a complex object detector. A status of the object tracker can be updated to a still status in a current video frame of the sequence of video frames. A tracker having the still status is associated with an object that is static in one or more video frames of the sequence of video frames. The object can be tracked in the current video frame using the object tracker based on the status of the object tracker being updated to the still status in the current video frame. For example, a bounding region of the object tracker in the current frame can be replaced with a previous bounding region of the object tracker in a previous frame based on the status of the object tracker being updated to the still status in the current video frame.

### CROSS-REFERENCE TO RELATED APPLICATIONS

This application claims the benefit of U.S. Provisional Application No. 62/578,926, filed Oct. 30, 2017, which is hereby incorporated by reference, in its entirety and for all purposes.

### FIELD

The present disclosure generally relates to video analytics for detecting and tracking objects, and more specifically to tracking still and slow objects in a hybrid video analytics system that includes complex object detection.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption. In some cases, the video data can also be processed by the devices and systems themselves.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. The system with the video analytics can be on a camera device and/or on a server. In some cases, video analytics can send alerts or alarms for certain events of interest. More advanced video analytics is needed to provide efficient and robust video sequence processing.

### BRIEF SUMMARY

In some examples, techniques are described for tracking still and slow objects in a hybrid video analytics system that performs object detection. The object detection combines blob detection and complex object detection to more accurately detect objects in the images. For example, a blob detection component of a video analytics system can use image data from one or more video frames to generate or identify blobs for the one or more video frames. A blob represents at least a portion of one or more objects in a video frame (also referred to as a “picture”). Blob detection can utilize background subtraction to determine a background portion of a scene and a foreground portion of scene. Blobs can then be detected based on the foreground portion of the scene. Blob bounding regions (e.g., bounding boxes or other bounding region) can be associated with the blobs, in which case a blob and a blob bounding region can be used interchangeably. A blob bounding region is a shape surrounding a blob, and can be used to represent the blob.

A complex object detector can be used to detect (e.g., classify and/or localize) objects in one or more images. In some cases, the complex object detector can be part of a complex object detector system and can apply a trained classification network. For instance, the complex object detector can apply a deep learning neural network (also referred to as deep networks and deep neural networks) to identify objects in an image based on past information about similar objects that the detector has learned based on training data (e.g., training data can include images of objects used to train the system). Any suitable type of deep learning network can be used, including convolutional neural networks (CNNs), autoencoders, deep belief nets (DBNs), Recurrent Neural Networks (RNNs), among others. One illustrative example of a deep learning network detector that can be used includes a single-shot object detector (SSD). Another illustrative example of a deep learning network detector that can be used includes a You only look once (YOLO) detector. Any other suitable deep network-based detector can be used.

In some cases, the hybrid video analytics system can apply the complex object detector at a very low frequency, while background subtraction based tracking and detection can be performed for the majority of the frames. For example, the complex object detector can apply neural network-based object detection (e.g., using a trained network) every N frames, with N being determined based on the delay required to process a frame using the deep learning network and the frame rate of the video sequence. Each frame for which the complex object detector is applied is referred to as a key frame. For other frames (non-key frames), blob detection is applied without also applying the complex object detector. An object classified by the complex object detector can be localized using a bounding region (e.g., a bounding box or other bounding region) representing the classified object. A bounding region generated using the complex object detector is referred to herein as a detector bounding region or high confidence bounding region. For key frames, the bounding regions from the neural network-based object detection and the bounding regions from background subtraction can be combined to generate a final set of bounding regions for tracking. For non-key frames, the bounding regions from the key frames can be used assist in the tracking process.

Background subtraction encounters issues when dealing with still objects (also referred to as static objects or sleeping objects). A still object is an object moving through a scene that becomes stationary, or that is moving slowly through the scene. A blob (and the object represented by the blob) can be detected and further tracked based on background subtraction as long as the object is in motion. However, in some cases, it is possible for a moving object in a scene to stop moving or to move very slowly. For such a still object, the background subtraction model will transition the pixels of the object from foreground pixels to background pixels due to the nature of background subtraction adapting to local changes quickly, causing the object and its blob to fade into the background and no longer be detected and tracked. For such slow or still objects, the associated blobs for such objects may become very small or even empty. In this case, an object may disappear and/or reappear with a similar a different tracker label.

The techniques and systems described herein operate to track still objects and slow moving objects using the key frame detection results from a complex detector. By using the key frame detection results, a slow or still object can be detected for non-key frames and tracking of such objects can be performed smoothly, thus providing temporally consistent tracking results.

According to at least one example, a method of tracking objects in a sequence of video frames is provided. The method includes identifying an object tracker maintained for the sequence of video frames. An object tracked by the object tracker is detected based on an application of an object detector to at least one key frame in the sequence of video frames. The method further includes updating a status of the object tracker to a still status in a current video frame of the sequence of video frames. The object tracker having the still status is associated with an object that is static in one or more video frames of the sequence of video frames. A still tracker is associated with an object that is static in one or more video frames of the sequence of video frames. The method further includes tracking the object in the current video frame using the object tracker based on the status of the object tracker being updated to the still status in the current video frame.

In another example, an apparatus for tracking objects in a sequence of video frames is provided that includes a memory configured to store one or more video frames of the sequence of video frames and a processor. The processor is configured to and can identify an object tracker maintained for the sequence of video frames. An object tracked by the object tracker is detected based on an application of an object detector to at least one key frame in the sequence of video frames. The processor is further configured to and can update a status of the object tracker to a still status in a current video frame of the sequence of video frames. The object tracker having the still status is associated with an object that is static in one or more video frames of the sequence of video frames. A still tracker is associated with an object that is static in one or more video frames of the sequence of video frames. The processor is further configured to track the object in the current video frame using the object tracker based on the status of the object tracker being updated to the still status in the current video frame.

In another example, a non-transitory computer-readable medium is provided that has stored thereon instructions that, when executed by one or more processors, cause the one or more processor to: identify an object tracker maintained for the sequence of video frames, wherein an object tracked by the object tracker is detected based on an application of an object detector to at least one key frame in the sequence of video frames; update a status of the object tracker to a still status in a current video frame of the sequence of video frames, wherein the object tracker having the still status is associated with an object that is static in one or more video frames of the sequence of video frames; and track the object in the current video frame using the object tracker based on the status of the object tracker being updated to the still status in the current video frame.

In another example, an apparatus for tracking objects in a sequence of video frames is provided. The apparatus includes means for identifying an object tracker maintained for the sequence of video frames. An object tracked by the object tracker is detected based on an application of an object detector to at least one key frame in the sequence of video frames. The apparatus further includes means for updating a status of the object tracker to a still status in a current video frame of the sequence of video frames. The object tracker having the still status is associated with an object that is static in one or more video frames of the sequence of video frames. A still tracker is associated with an object that is static in one or more video frames of the sequence of video frames. The apparatus further includes means for tracking the object in the current video frame using the object tracker based on the status of the object tracker being updated to the still status in the current video frame.

In some aspects, the object detector is a complex object detector. In some aspects, the object detector is based on a trained classification network. As used herein, a key frame is a frame from the sequence of video frames to which the object detector is applied. In some cases, blob detection is performed for each video frame of the sequence of video frames to detect one or more blobs in each video frame, and the object detector is applied only to key frames of the sequence of video frames. The frames that the object detector (e.g., the complex object detector) is not applied to are referred to as non-key frames.

In some aspects, the methods, apparatuses, and computer-readable medium described above further comprise assigning a bounding region to the object tracker for tracking the object in the current video frame, where the assigned bounding region is generated by the object detector at the at least one key frame. In some cases, the methods, apparatuses, and computer-readable medium described above further comprise replacing a bounding region of the object tracker in the current frame with a previous bounding region of the object tracker in the at least one key frame based on the status of the object tracker being updated to the still status in the current video frame. In some examples, the previous bounding region is assigned to the object tracker for tracking the object in the current video frame, and wherein the previous bounding region is generated by the object detector when processing the at least one key frame.

In some aspects, the methods, apparatuses, and computer-readable medium described above further comprise maintaining a key frame bounding region list for the object tracker. The key frame bounding region list includes a plurality of entries. Each entry in the key frame bounding region list includes a bounding region detected by the object detector in a key frame in the sequence of video frames. In some examples, each entry in the key frame bounding region list further includes a frame difference between the current video frame and the key frame when the bounding region of each entry was detected.

In some aspects, updating the status of the object tracker to the still status includes: determining a number of the plurality of entries in the key frame bounding region list includes at least a threshold number of entries; and updating the status of the object tracker to the still status based on the number of the plurality of entries including at least the threshold number of entries.

In some aspects, updating the status of the object tracker to the still status includes: determining the plurality of entries in the key frame bounding region list does not include any empty entries, wherein an entry associated with a key frame is set to empty when an object associated with the object tracker is not detected by the object detector in the key frame; and updating the status of the object tracker to the still status based on the plurality of entries in the key frame bounding region list not including any empty entries.

In some aspects, updating the status of the object tracker to the still status includes: determining a spatial relationship between two bounding regions from the key frame bounding region list; determining the spatial relationship is larger than a spatial threshold; and updating the status of the object tracker to the still status based on the spatial relationship being larger than the spatial threshold. In some cases, the two bounding regions from the key frame bounding region list are based on detection performed for two most recent key frames to the current video frame in the sequence of video frames. In some cases, determining the spatial relationship includes determining an intersection-over-union between the two bounding regions.

In some aspects, updating the status of the object tracker to the still status includes: determining an amount of movement between a first bounding region and a second bounding region from the plurality of entries of the key frame bounding region list; determining the amount of movement is less than a movement threshold; and updating the status of the object tracker to the still status based on the amount of movement being less than the movement threshold. In some cases, the amount of movement is determined in a horizontal direction, in a vertical direction, or in the horizontal direction and the vertical direction.

In some aspects, the methods, apparatuses, and computer-readable medium described above further comprise determining the object tracked by the object tracker is not detected in the current video frame. In such aspects, based on the status of the object tracker being updated to the still status, the object is tracked in the current video frame using the object tracker when the object tracked by the object tracker is not detected in the current video frame.

In some aspects, the methods, apparatuses, and computer-readable medium described above further comprise: determining the object tracked by the object tracker is detected in the current video frame; determining, when the object is detected in the current video frame and when the status of the object tracker is updated to the still status, the object tracker includes one or more vanishing bounding regions based on a plurality of bounding regions in a history of bounding regions for the object tracker being constrained by a bounding region generated by the object detector at the at least one key frame; and tracking the object in the current video frame using the object tracker based on the status of the object tracker being updated to the still status and based on the object tracker being determined to be vanishing.

In some aspects, the history of bounding regions for the object tracker include bounding regions of the object tracker in video frames between the current video frame and a most recent key frame to the current video frame in the sequence of video frames.

In some aspects, the methods, apparatuses, and computer-readable medium described above further comprise: identifying an additional object tracker maintained for the sequence of video frames, wherein an additional object tracked by the additional object tracker is detected based on application of the object detector to the at least one key frame; determining the additional object tracked by the additional object tracker is not detected in the current video frame; determining a status of the additional object tracker is not a still status; determining, when the additional object is not detected in the current video frame and when the status of the object tracker is not determined to be the still status, the additional object tracker includes one or more vanishing bounding regions based on a plurality of bounding regions in a history of bounding regions for the additional object tracker being constrained by a bounding region generated by the object detector at the at least one key frame; and tracking the additional object in the current video frame using the additional object tracker when the additional object tracker is determined to be vanishing.

In some aspects, the methods, apparatuses, and computer-readable medium described above further comprise: identifying an additional object tracker maintained for the sequence of video frames, wherein an additional object tracked by the additional object tracker is detected based on application of the object detector to the at least one key frame; determining the additional object tracked by the additional object tracker is detected in the current video frame; determining a status of the additional object tracker is not a still status; applying a bounding region refinement process to a bounding region of the additional object tracker for the current video frame based on the additional object being detected in the current video frame and based on the status of additional object tracker not being the still status; and tracking the additional object in the current video frame using the bounding region of the additional object tracker.

In some cases, the bounding region refinement process replaces a current bounding region of the additional object tracker from current video frame with a previous bounding region of the additional object tracker from a previous video frame.

In some cases, applying the bounding region refinement process includes: obtaining a previous bounding region of the additional object tracker from a previous video frame, a key bounding region generated by the object detector at the at least one key frame, and a current bounding region of the additional object tracker from current video frame; determining a size of the current bounding region is less than a threshold percentage of a size of the key bounding region; and replacing the current bounding region with the previous bounding region based on the size of the current bounding region being less than the threshold percentage of the size of the key bounding region.

In some aspects, applying the bounding region refinement process includes: obtaining a previous bounding region of the additional object tracker from a previous video frame, a key bounding region generated by the object detector at the at least one key frame, and a current bounding region of the additional object tracker from current video frame; determining a first overlapping region between the current bounding region and the key bounding region; determining a second overlapping region between the current bounding region and the previous bounding region; and replacing the current bounding region with the previous bounding region based on at least one or more of a size of the first overlapping region being less than a first threshold percentage of a size of the key bounding region or a size of the second overlapping region being less than a second threshold percentage of the size of the key bounding region.

In some aspects, the methods, apparatuses, and computer-readable medium described above further comprise: determining the object tracker is not a false positive tracker based on a history of bounding regions associated with the object tracker; and updating the status of the object tracker to the still status when the object tracker is determined not to be a false positive tracker.

In some aspects, the history includes bounding regions from each video frame between a frame at which the object tracker was created and a key frame at which the object tracked by the object tracker is detected by the object detector. In such aspects, the object tracker is determined not to be a false positive tracker based on the bounding regions in the history being larger than a threshold number of bounding regions.

In some aspects, the history includes bounding regions from each video frame between the current video frame and a last key frame at which the object tracked by the object tracker is detected by the object detector. In such aspects, the object tracker is determined not to be a false positive tracker based on the bounding regions in the history being larger than a threshold number of bounding regions.

In some aspects, the history includes bounding regions from each video frame between the current video frame and a last key frame at which the object tracked by the object tracker is detected by the object detector. In such aspects, the object tracker is determined not to be a false positive tracker based on at least one bounding region in the history being larger than a threshold size of a key bounding region from the last key frame.

In some aspects, the apparatus comprises a mobile device. In some aspects, the apparatus comprises a camera for capturing the one or more images. In some cases, the apparatus comprises a display for displaying the one or more images. In some cases, the apparatus comprises a mobile device with a camera for capturing the one or more images and a display for displaying the one or more images.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example of a system including a video source and a video analytics system, in accordance with some examples.

FIG. 2 is an example of a video analytics system processing video frames, in accordance with some examples.

FIG. 3 is a block diagram illustrating an example of a blob detection system, in accordance with some examples.

FIG. 4 is a block diagram illustrating an example of an object tracking system, in accordance with some examples.

FIG. 5 is a video frame of an environment with various objects, in accordance with some examples.

FIG. 6 is a video frame of an environment with various objects, in accordance with some examples.

FIG. 7 is a video frame of an environment with various objects, in accordance with some examples.

FIG. 8 is a video frame of an environment with an object, in accordance with some examples.

FIG. 9A-FIG. 9C are video frames of an environment with an object moving through the environment, in accordance with some examples.

FIG. 10 is a block diagram illustrating an example of a hybrid video analytics system, in accordance with some examples.

FIG. 11 is a flowchart illustrating an example of a process for processing trackers, in accordance with some examples.

FIG. 12 is a flowchart illustrating an example of a stable tracker determination process, in accordance with some examples.

FIG. 13 is a flowchart illustrating an example of a process for detecting still trackers, in accordance with some examples.

FIG. 14 is a diagram illustrating an example of an intersection and union of two bounding boxes, in accordance with some examples.

FIG. 15 is a block diagram illustrating an example of a deep learning network, in accordance with some examples.

FIG. 16 is a block diagram illustrating an example of a convolutional neural network, in accordance with some examples.

FIG. 17A-FIG. 17C are diagrams illustrating an example of a single-shot object detector, in accordance with some examples.

FIG. 18A-FIG. 18C are diagrams illustrating an example of a you only look once (YOLO) detector, in accordance with some examples.

FIG. 19 is a video frame of an environment with an object, in accordance with some examples.

FIG. 20 is a video frame of an environment with an object, in accordance with some examples.

FIG. 21 is a video frame of an environment with an object, in accordance with some examples.

FIG. 22 is a video frame of an environment with two objects, in accordance with some examples.

FIG. 23 is a video frame of an environment with three objects, in accordance with some examples.

FIG. 24 is a video frame of an environment with an object, in accordance with some examples.

FIG. 25 is a video frame of an environment with an object, in accordance with some examples.

FIG. 26 is a video frame of an environment with two objects, in accordance with some examples.

FIG. 27 is a flowchart illustrating an example of an object tracking process, in accordance with some embodiments.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a sequence of video frames from a video source and can process the video sequence to perform a variety of tasks. One example of a video source can include an Internet protocol camera (IP camera) or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and can send an alert or alarm to a central control room to alert a user of the event of interest.

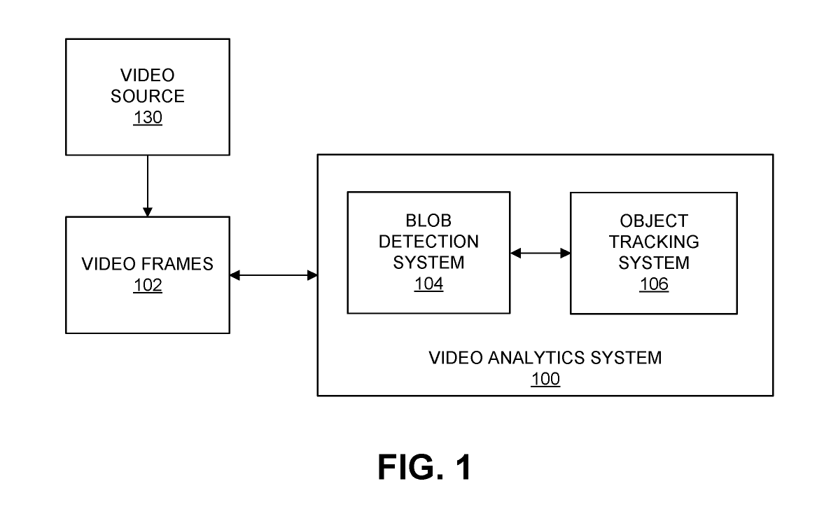

As described in more detail herein, a video analytics system can generate and detect foreground blobs that can be used to perform various operations, such as object tracking (also called blob tracking) and/or the other operations described above. A blob tracker (also referred to as an object tracker) can be used to track one or more blobs in a video sequence using one or more bounding boxes. Details of an example video analytics system with blob detection and object tracking are described below with respect to FIG. 1-FIG. 4.

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection system 104 and an object tracking system 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection system 104 can detect one or more blobs in video frames (e.g., video frames 102) of a video sequence, and the object tracking system 106 can track the one or more blobs across the frames of the video sequence. As used herein, a blob refers to foreground pixels of at least a portion of an object (e.g., a portion of an object or an entire object) in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob. In some examples, a tracker can also be represented by a tracker bounding region. A bounding region of a blob or tracker can include a bounding box, a bounding circle, a bounding ellipse, or any other suitably-shaped region representing a tracker and/or a blob. While examples are described herein using bounding boxes for illustrative purposes, the techniques and systems described herein can also apply using other suitably shaped bounding regions. A bounding box associated with a tracker and/or a blob can have a rectangular shape, a square shape, or other suitable shape. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated. Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

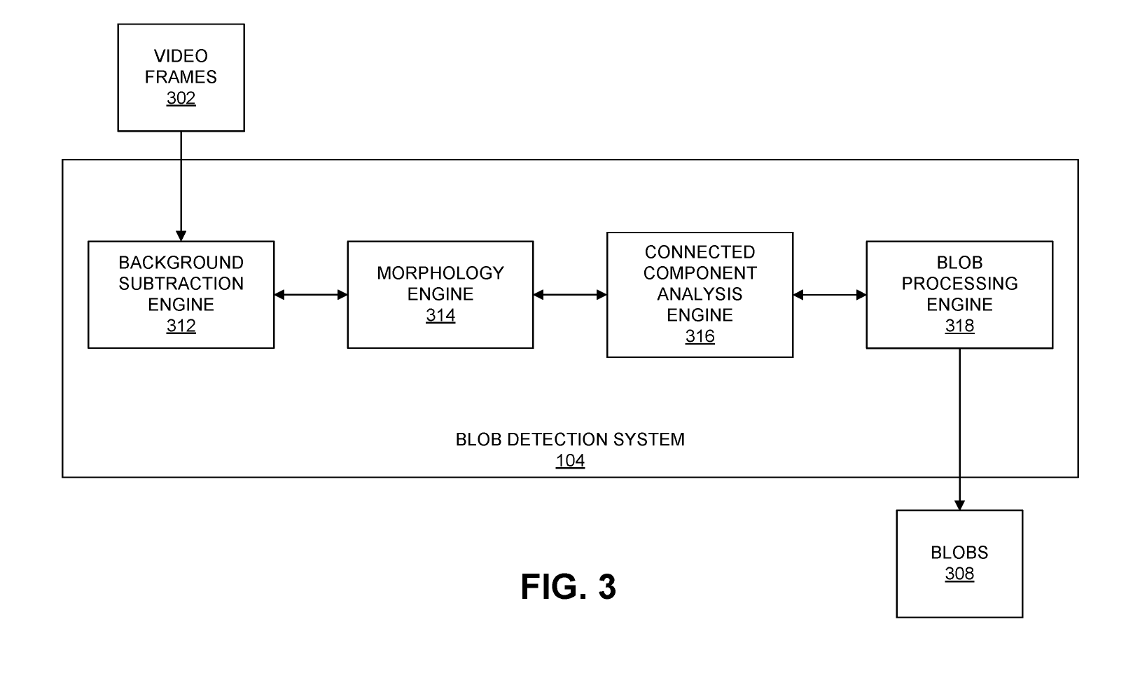

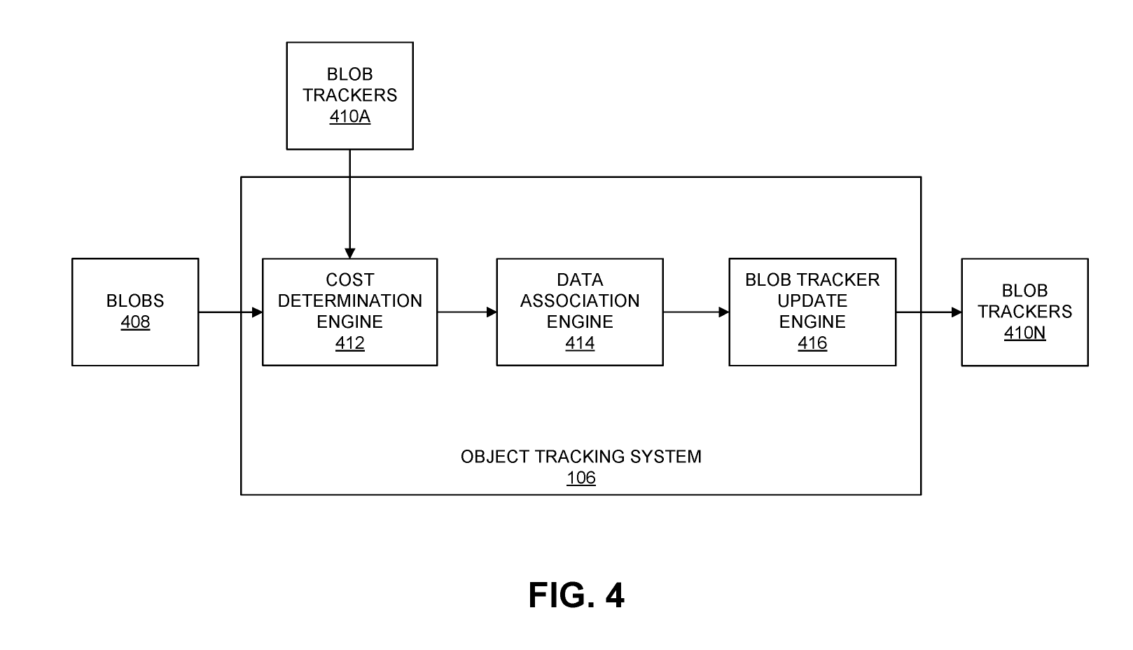

Using the blob detection system 104 and the object tracking system 106, the video analytics system 100 can perform blob generation and detection for each frame or picture of a video sequence. For example, the blob detection system 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection system 104 and the object tracking system 106 are described with respect to FIGS. 3-4.

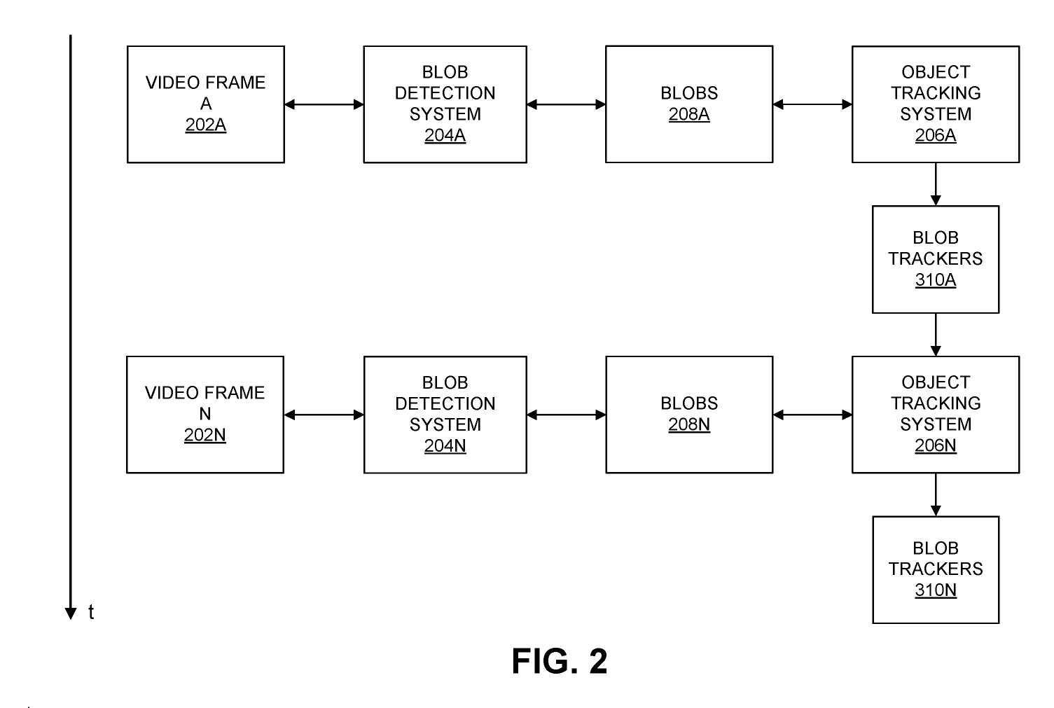

FIG. 2 is an example of the video analytics system (e.g., video analytics system 100) processing video frames across time t. As shown in FIG. 2, a video frame A 202A is received by a blob detection system 204A. The blob detection system 204A generates foreground blobs 208A for the current frame A 202A. After blob detection is performed, the foreground blobs 208A can be used for temporal tracking by the object tracking system 206A. Costs (e.g., a cost including a distance, a weighted distance, or other cost) between blob trackers and blobs can be calculated by the object tracking system 206A. The object tracking system 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection system 204N generates foreground blobs 208N for the frame N 202N. The object tracking system 206N can then perform temporal tracking of the blobs 208N. For example, the object tracking system 206N obtains the blob trackers 310A that were updated based on the prior video frame A 202A. The object tracking system 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection system 104. Blob detection is used to segment moving objects from the global background in a scene. The blob detection system 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (also referred to as a Gaussian mixture model (GMM)). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

$$P ( {X}_{t} ) = {\sum }_{i = 1}^{K} {ω}_{i , t} N ( {X}_{t} \vert {μ}_{i , t} , {Σ}_{i , t} ) \qquad Equation ( 1 )$$

An equation of the GMM model is shown in equation (1), wherein there are K Gaussian models. Each Guassian model has a distribution with a mean of μ and variance of Σ, and has a weight ω. Here, i is the index to the Gaussian model and t is the time instance. As shown by the equation, the parameters of the GMM change over time after one frame (at time t) is processed. In GMM or any other learning based background subtraction, the current pixel impacts the whole model of the pixel location based on a learning rate, which could be constant or typically at least the same for each pixel location. A background subtraction method based on GMM (or other learning based background subtraction) adapts to local changes for each pixel. Thus, once a moving object stops, for each pixel location of the object, the same pixel value keeps on contributing to its associated background model heavily, and the region associated with the object becomes background.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with 3×3 window size is called first, and three function calls of dilation of 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. In some implementation of connected component analysis, a set of bounding boxes are returned in a way that each bounding box contains one component of connected pixels. One example of the connected component analysis performed by the connected component analysis engine 316 is implemented as follows:

```
for each pixel of the foreground mask {
-if it is a foreground pixel and has not been processed, the
following steps apply:
    -Apply FloodFill function to connect this pixel to other
    foreground and generate a connected component
    -Insert the connected component in a list of connected components.
    -Mark the pixels in the connected component as being processed }
```

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection system 104. In some examples, there may be a filtering process for the connected components (bounding boxes). For instance, the blob processing engine 318 can perform content-based filtering of certain blobs. In some cases, a machine learning method can determine that a current blob contains noise (e.g., foliage in a scene). Using the machine learning information, the blob processing engine 318 can determine the current blob is a noisy blob and can remove it from the resulting blobs that are provided to the object tracking system 106. In some cases, the blob processing engine 318 can filter out one or more small blobs that are below a certain size threshold (e.g., an area of a bounding box surrounding a blob is below an area threshold). In some examples, there may be a merging process to merge some connected components (represented as bounding boxes) into bigger bounding boxes. For instance, the blob processing engine 318 can merge close blobs into one big blob to remove the risk of having too many small blobs that could belong to one object. In some cases, two or more bounding boxes may be merged together based on certain rules even when the foreground pixels of the two bounding boxes are totally disconnected. In some embodiments, the blob detection system 104 does not include the blob processing engine 318, or does not use the blob processing engine 318 in some instances. For example, the blobs generated by the connected component analysis engine 316, without further processing, can be input to the object tracking system 106 to perform blob and/or object tracking.

In some implementations, density based blob area trimming may be performed by the blob processing engine 318. For example, when all blobs have been formulated after post-filtering and before the blobs are input into the tracking layer, the density based blob area trimming can be applied. A similar process is applied vertically and horizontally. For example, the density based blob area trimming can first be performed vertically and then horizontally, or vice versa. The purpose of density based blob area trimming is to filter out the columns (in the vertical process) and/or the rows (in the horizontal process) of a bounding box if the columns or rows only contain a small number of foreground pixels.

The vertical process includes calculating the number of foreground pixels of each column of a bounding box, and denoting the number of foreground pixels as the column density. Then, from the left-most column, columns are processed one by one. The column density of each current column (the column currently being processed) is compared with the maximum column density (the column density of all columns). If the column density of the current column is smaller than a threshold (e.g., a percentage of the maximum column density, such as 10%, 20%, 30%, 50%, or other suitable percentage), the column is removed from the bounding box and the next column is processed. However, once a current column has a column density that is not smaller than the threshold, such a process terminates and the remaining columns are not processed anymore. A similar process can then be applied from the right-most column. One of ordinary skill will appreciate that the vertical process can process the columns beginning with a different column than the left-most column, such as the right-most column or other suitable column in the bounding box.

The horizontal density based blob area trimming process is similar to the vertical process, except the rows of a bounding box are processed instead of columns. For example, the number of foreground pixels of each row of a bounding box is calculated, and is denoted as row density. From the top-most row, the rows are then processed one by one. For each current row (the row currently being processed), the row density is compared with the maximum row density (the row density of all the rows). If the row density of the current row is smaller than a threshold (e.g., a percentage of the maximum row density, such as 10%, 20%, 30%, 50%, or other suitable percentage), the row is removed from the bounding box and the next row is processed. However, once a current row has a row density that is not smaller than the threshold, such a process terminates and the remaining rows are not processed anymore. A similar process can then be applied from the bottom-most row. One of ordinary skill will appreciate that the horizontal process can process the rows beginning with a different row than the top-most row, such as the bottom-most row or other suitable row in the bounding box.

One purpose of the density based blob area trimming is for shadow removal. For example, the density based blob area trimming can be applied when one person is detected together with his or her long and thin shadow in one blob (bounding box). Such a shadow area can be removed after applying density based blob area trimming, since the column density in the shadow area is relatively small. Unlike morphology, which changes the thickness of a blob (besides filtering some isolated foreground pixels from formulating blobs) but roughly preserves the shape of a bounding box, such a density based blob area trimming method can dramatically change the shape of a bounding box.

Once the blobs are detected and processed, object tracking (also referred to as blob tracking) can be performed to track the detected blobs. FIG. 4 is a block diagram illustrating an example of an object tracking system 106. The input to the blob/object tracking is a list of the blobs 408 (e.g., the bounding boxes of the blobs) generated by the blob detection system 104. In some cases, a tracker is assigned with a unique ID, and a history of bounding boxes is kept. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking system 106 can obtain the blobs 408 of a current video frame from the blob detection system 104. The cost determination engine 412 can also obtain the blob trackers 410A updated from the previous video frame (e.g., video frame A 202A). A cost function can then be used to calculate costs between the blob trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker (or tracker bounding box) with a corresponding blob (or blob bounding box) and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible. Regardless of the association technique that is used, the data association engine 414 can rely on the distance between the blobs and trackers.

Once the association between the blob trackers 410A and blobs 408 has been completed, the blob tracker update engine 416 can use the information of the associated blobs, as well as the trackers' temporal statuses, to update the status (or states) of the trackers 410A for the current frame. Upon updating the trackers 410A, the blob tracker update engine 416 can perform object tracking using the updated trackers 410N, and can also provide the updated trackers 410N for use in processing a next frame.

The status or state of a blob tracker can include the tracker's identified location (or actual location) in a current frame and its predicted location in the next frame. The location of the foreground blobs are identified by the blob detection system 104. However, as described in more detail below, the location of a blob tracker in a current frame may need to be predicted based on information from a previous frame (e.g., using a location of a blob associated with the blob tracker in the previous frame). After the data association is performed for the current frame, the tracker location in the current frame can be identified as the location of its associated blob(s) in the current frame. The tracker's location can be further used to update the tracker's motion model and predict its location in the next frame. Further, in some cases, there may be trackers that are temporarily lost (e.g., when a blob the tracker was tracking is no longer detected), in which case the locations of such trackers also need to be predicted (e.g., by a Kalman filter). Such trackers are temporarily not shown to the system. Prediction of the bounding box location helps not only to maintain certain level of tracking for lost and/or merged bounding boxes, but also to give more accurate estimation of the initial position of the trackers so that the association of the bounding boxes and trackers can be made more precise.

As noted above, the location of a blob tracker in a current frame may be predicted based on information from a previous frame. One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) (e.g., the blob(s) bounding box(es)) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, the state or status of a tracker can also, or alternatively, include a tracker's temporal status. The temporal status can include whether the tracker is a new tracker that was not present before the current frame, whether the tracker has been alive for certain frames, or other suitable temporal status. Other states can include, additionally or alternatively, whether the tracker is considered as lost when it does not associate with any foreground blob in the current frame, whether the tracker is considered as a dead tracker if it fails to associate with any blobs for a certain number of consecutive frames (e.g., two or more), or other suitable tracker states.

There may be other status information needed for updating the tracker, which may require a state machine for object tracking. Given the information of the associated blob(s) and the tracker's own status history table, the status also needs to be updated. The state machine collects all the necessary information and updates the status accordingly. Various statuses can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration (a threshold duration) has passed, the tracker may be promoted to be a normal tracker. A normal tracker is output as an identified tracker-blob pair. For example, a tracker-blob pair is output at the system level as an event (e.g., presented as a tracked object on a display, output as an alert, and/or other suitable event) when the tracker is promoted to be a normal tracker. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by a rule interpreter). A tracker that is not promoted as a normal tracker can be removed (or killed), after which the tracker can be considered as dead.

As noted above, blob trackers can have various temporal states, such as a new state for a tracker of a current frame that was not present before the current frame, a lost state for a tracker that is not associated or matched with any foreground blob in the current frame, a dead state for a tracker that fails to associate with any blobs for a certain number of consecutive frames (e.g., 2 or more frames, a threshold duration, or the like), a normal state for a tracker that is to be output as an identified tracker-blob pair to the video analytics system, or other suitable tracker states. Another temporal state that can be maintained for a blob tracker is a duration of the tracker. The duration of a blob tracker includes the number of frames (or other temporal measurement, such as time) the tracker has been associated with one or more blobs.

As described above, video analytics systems that use motion-based object/blob detection and tracking mainly track moving objects detected as a set of blobs. Each blob does not necessarily correspond to an object. In addition, each blob may not necessarily correspond to a truly moving object. Since the motion detection is performed using background subtraction, the complexity of the solution is not proportional to the number of moving objects in the scene. However, a benefit of video analytics systems that rely on motion-based object/blob detection is that such systems can be performed by relatively low power devices (e.g., less powerful IP camera (IPC) devices). For example, such a video analytics solution could be implemented in a low complexity arm-based chip set, such as the Qualcomm Snapdragon™ 625 (SD625 or the APQ8053 chip). Such a solution could even offer real-time performance (e.g., 30 fps) utilizing only 1 CPU core.

However, such a solution may not be accurate in some scenarios. In some cases, inconsistent motion trajectory of an object can lead to missed detections. For example, a moving object typically triggers a continuous set of detected blobs in successive video frames. These detections (as recorded by a history of blobs) serve as the initial motion trajectory of a candidate that can subsequently be considered as a tracked object (e.g., if the threshold duration is met, and/or other condition is met). However, there can be several causes for the trajectory not triggering a true positive object to be reported in the system. One cause can include that the trajectory is broken in one video frame, resulting in the whole object being killed. Illustrative reasons that the trajectory can be broken include bad lighting conditions that result in a failed object detection for one or more frames, an object becoming merged with another object and no longer contributing to an individual initial motion trajectory of an existing object, as well as various other reasons. Another cause for the trajectory not triggering a true positive object can include that the trajectory of an object does not appear to resemble a typical moving object, such as when movement associated with the initial motion trajectory is small, when the blob sizes associated with the initial motion trajectory are quite inconsistent, among other cases.

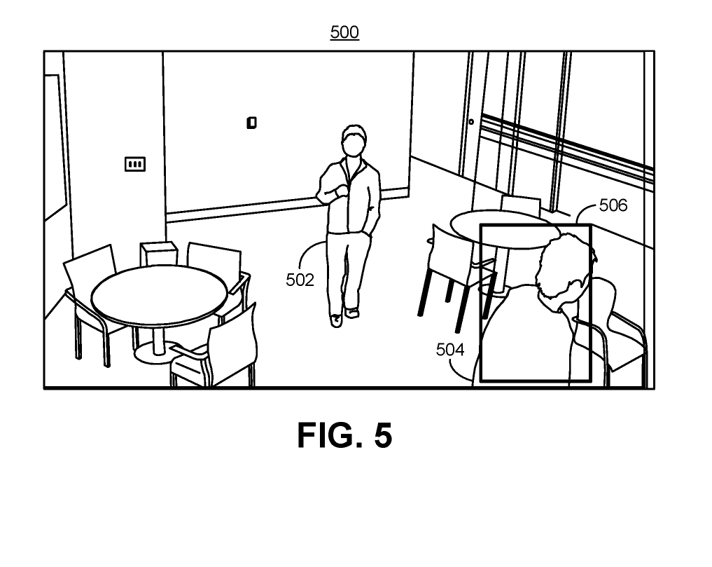

FIG. 5 shows a video frame 500 illustrating a situation when an object (person 502) is not detected. For example, person 504 is detected and is tracked (shown by bounding box 506) by the video analytics system. However, the person 502 is not detected and thus is not tracked in the video frame 500. As noted above, the person 502 may not be detected and tracked due to lighting conditions and/or due to the movement of the person 502 being too small.

Another reason a motion-based video analytics systems can be inaccurate is due to a long duration (the threshold duration) being required to confirm whether an object is a true positive or not. For example, the initial motion trajectory of an object may require a threshold duration of, for example, a half second, one second, or other suitable duration. When the system determines the initial motion trajectory is not sufficient to output the object, it may wait for several more cycles of the threshold duration (e.g., another half second or another one second). In such cases, a typical tracking delay can be as large as two seconds or even four seconds in some extreme cases. Such tracking delay can lead to missed detections if the object does not “live” long enough in the scene.

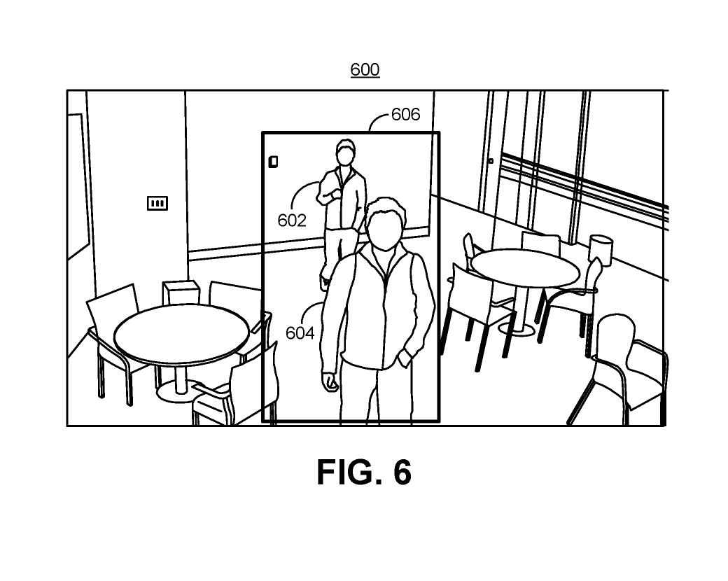

Furthermore, when multiple objects are detected as a single blob (a merge situation) and are tracked as a single object due to a merge situation, the video analytics system can have difficulties tracking the individual objects detected in the merged blob. For example, for indoor cases (e.g., indoor video surveillance applications), it is common to have objects merged together, since a detected blob may simply contain two or more objects. FIG. 6 shows a video frame 600 illustrating a situation when objects are merged together. For example, person 602 and person 604 are detected as a single blob and are merged together by the video analytics system. As a result, a single object is tracked by the video analytics system, as shown by bounding box 606. There is a need to maintain individuality in object detection and tracking in such merge cases, which can be difficult with motion-based video analytics system.

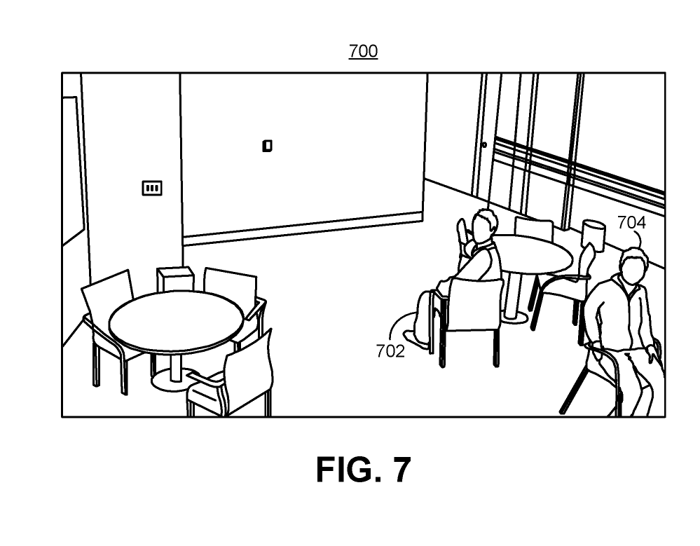

In some cases, foreground objects can be absorbed into the background as a result of a motion-based video analytics system relying on background subtraction for object detection. For example, objects may stop moving or can begin moving slowly, which are referred to as still or static objects. Still objects can gradually get absorbed into the background as the pixels representing the object are detected as background pixels. However, when the objects are not absolutely still or rigid, it can be difficult to use sleeping object detection-based techniques to detect and track such objects. An example of such a situation is illustrated by the video frame 700 shown in FIG. 7. As shown, the person 702 and the person 704 are sitting in chairs and thus are not moving. Due to the lack of movement, the persons 702 and 704 are not detected as foreground objects and also are not tracked by the video analytics system. Such a situation may occur more often in indoor environments.

Random movements from parts of a stopped object can also cause issues in video analytics systems. For example, parts of an object can continue to display motion even after the object stops moving (e.g., hands, heads, arms or other parts of people continue moving when the people are standing still). Motion blobs contributed by such smaller movements will be detected, but will only represent a small portion of the entire object. Such blobs should be effectively filtered out or otherwise used to indicate the movement or activity of the real object instead of parts of it.

To improve the accuracy of tracking an object, a complex detector can also be used to detect (e.g., classify and/or localize) objects in one or more video frames of a video sequence. For example, a complex detector can be based on a trained classification neural network, such as a deep learning network (also referred to herein as a deep network and a deep neural network), to detect (e.g., classify and/or localize) objects in a video frame. A trained deep learning network can identify objects in an image based on knowledge gleaned from training images (or other data) that include similar objects and labels indicating the classification of those objects.

A neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the network includes feature maps or activation maps that can include nodes. A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics. For a classification network, the deep learning network can classify an object in an image or video frame using the determined high-level features. The output can be a single class or category, a probability of classes that best describes the object, or other suitable output. For example, the output can include probability values indicating probabilities (or confidence levels or confidence values) that the object includes one or more classes of objects (e.g., a probability the object is a person, a probability the object is a dog, a probability the object is a cat, or the like).

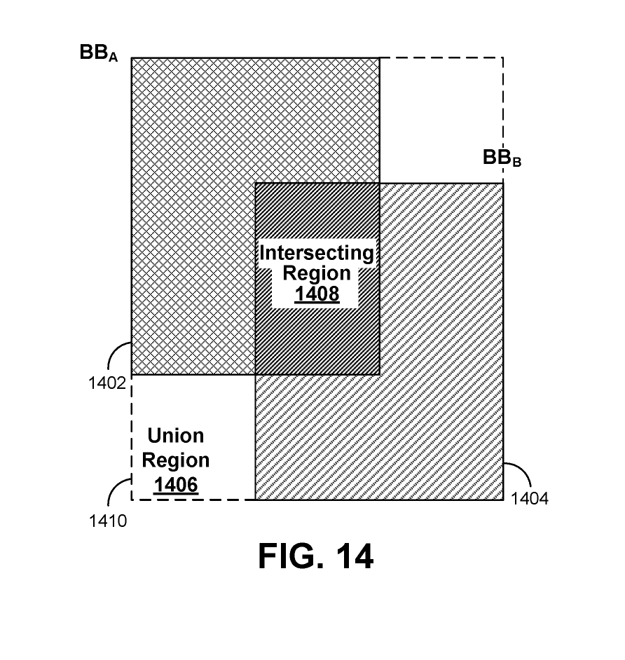

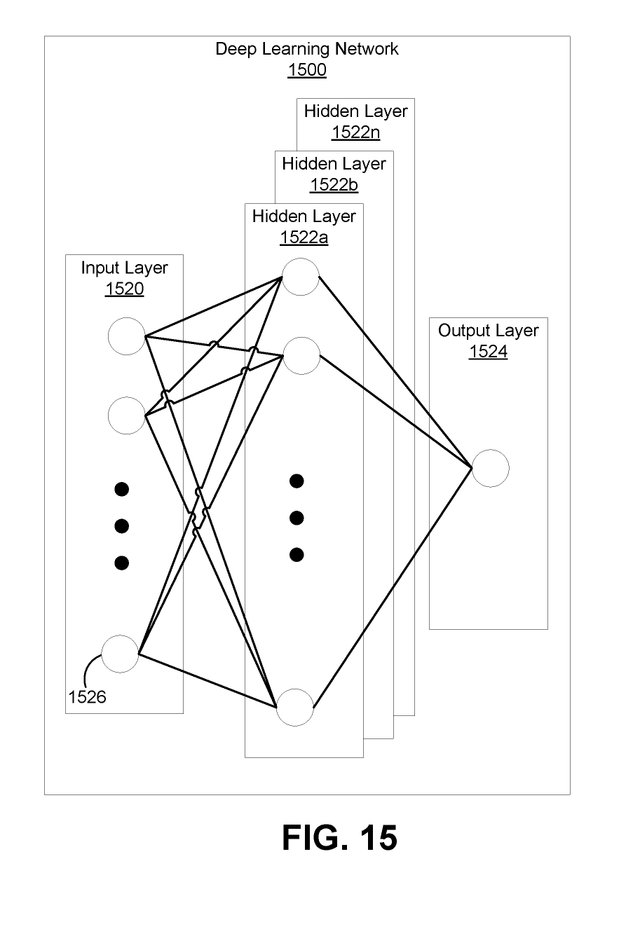

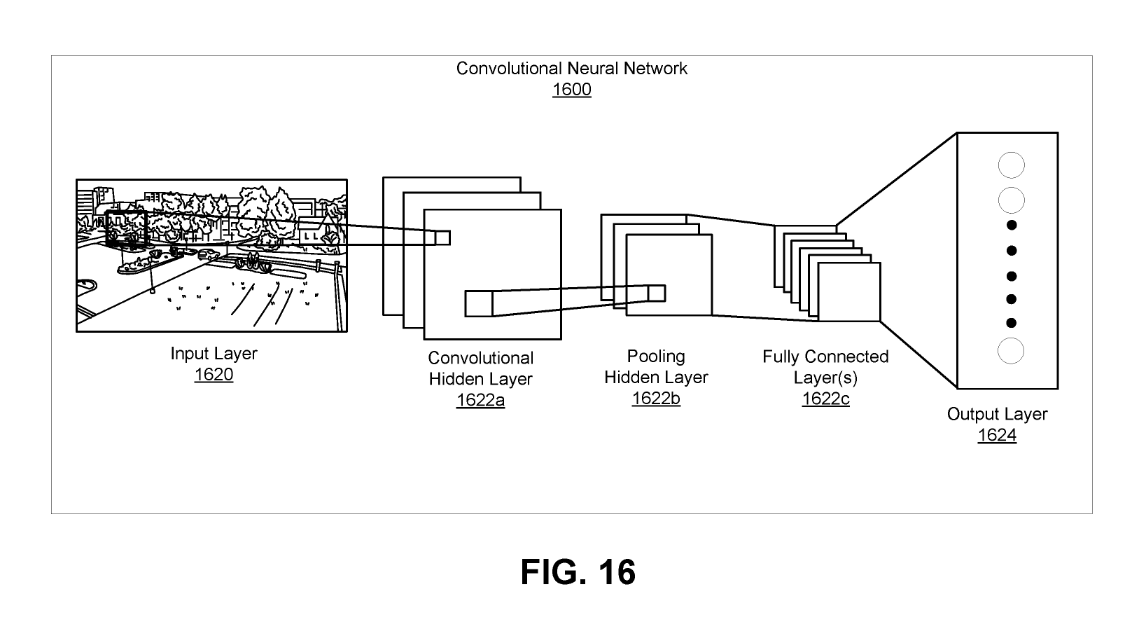

In some cases, nodes in the input layer can represent data, nodes in the one or more hidden layers can represent computations, and nodes in the output layer can represent results from the one or more hidden layers. In one illustrative example, a deep learning neural network can be used to determine whether an object in an image or a video frame is a person. In such an example, nodes in an input layer of the network can include normalized values for pixels of an image (e.g., with one node representing one normalized pixel value), nodes in a hidden layer can be used to determine whether certain common features of a person are present (e.g., two legs are present, a face is present at the top of the object, two eyes are present at the top left and top right of the face, a nose is present in the middle of the face, a mouth is present at the bottom of the face, and/or other features common for a person), and nodes of an output layer can indicate whether a person is detected or not. This example network can have a series of many hidden layers, with early layers determining low-level features of the object in the video frame (e.g., curves, edges, and/or other low-level features), and later layers building up a hierarchy of more high-level and abstract features of the object (e.g., legs, a head, a face, a nose, eyes, mouth, and/or other features). Based on the determined high-level features, the deep learning network can classify the object as being a person or not (e.g., based on a probability of the object being a person relative to a threshold value). Further details of the structure and function of neural networks are described below with respect to FIG. 15 and FIG. 16.

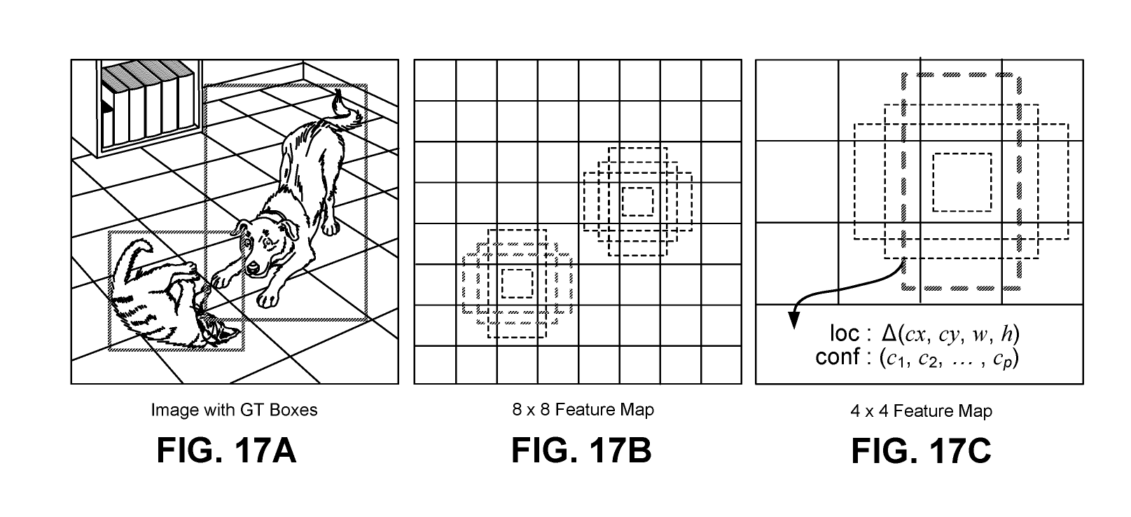

Various complex detectors can be used by a complex object detector system to detect or classify objects in video frames. For example, SSD is a fast single-shot object detector that can be applied for multiple object categories. A feature of the SSD model is the use of multi-scale convolutional bounding box outputs attached to multiple feature maps at the top of the neural network. Such a representation allows the SSD to efficiently model diverse box shapes. It has been demonstrated that, given the same VGG-16 base architecture, SSD compares favorably to its state-of-the-art object detector counterparts in terms of both accuracy and speed. An SSD deep learning detector is described in more detail in K. Simonyan and A. Zisserman, “Very deep convolutional networks for large-scale image recognition,” CoRR, abs/1409.1556, 2014, which is hereby incorporated by reference in its entirety for all purposes. Further details of the SSD detector are described below with respect to FIG. 17A-FIG. 17C.

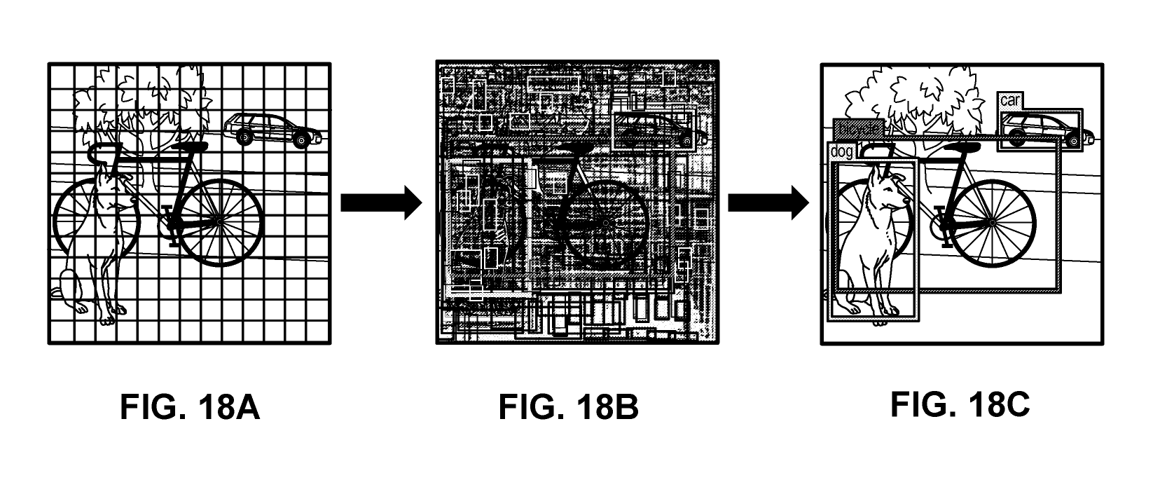

Another example of a complex detector that can be used to detect or classify objects in video frames includes the You only look once (YOLO) detector. The YOLO detector, when run on a Titan X, processes images at 40-90 fps with a mAP of 78.6% (based on VOC 2007). The SSD300 model runs at 59 FPS on the Nvidia Titan X, and can typically execute faster than the current YOLO 1. YOLO 1 has also been recently replaced by its successor YOLO 2. A YOLO deep learning detector is described in more detail in J. Redmon, S. Divvala, R. Girshick, and A. Farhadi, “You only look once: Unified, real-time object detection,” arXiv preprint arXiv:1506.02640, 2015, which is hereby incorporated by reference in its entirety for all purposes. Further details of the YOLO detector are described below with respect to FIG. 18A-FIG. 18C. While the SSD and YOLO detectors are described to provide illustrative examples of deep learning-based object detectors, one of ordinary skill will appreciate that any other suitable neural network can be used by the complex object detector system.

Complex detectors can also have issues when being used to classify and/or localize objects in a video sequence. For example, deep learning based complex detectors are quite slow and the results cannot be generated real-time on camera devices (e.g., at 30 fps), such as an IP camera device or other suitable device used to capture video sequences of a scene. Deep learning based complex detectors can only achieve real-time performance on certain graphic cards (e.g., an Nvidia graphics card). Experiments even suggest that it could take many seconds to finish object detection for one frame.

There are further optimizations in terms of deep learning algorithms, including using GoogLeNet v2 to replace VGG in SSD. In low-tier chipsets, such as the SD625, the CPUs are much slower and the absence of a high-performance vector-DSP, such as the HVX (Hexagon Vector eXtensions), prevents efficient parallel processing. In addition, the GPU in a SD625 chipset has performance capabilities that are far inferior to the Nvidia Titan X. So, the fastest deep learning-based detector (even by using the GPU) is still expected to consume 0.5-1 second for one frame. The above execution latency is many-fold (15-30×) inferior to that offered by a conventional video analytics solution for processing one frame, wherein 30 ms of latency is sufficient for the latter case.

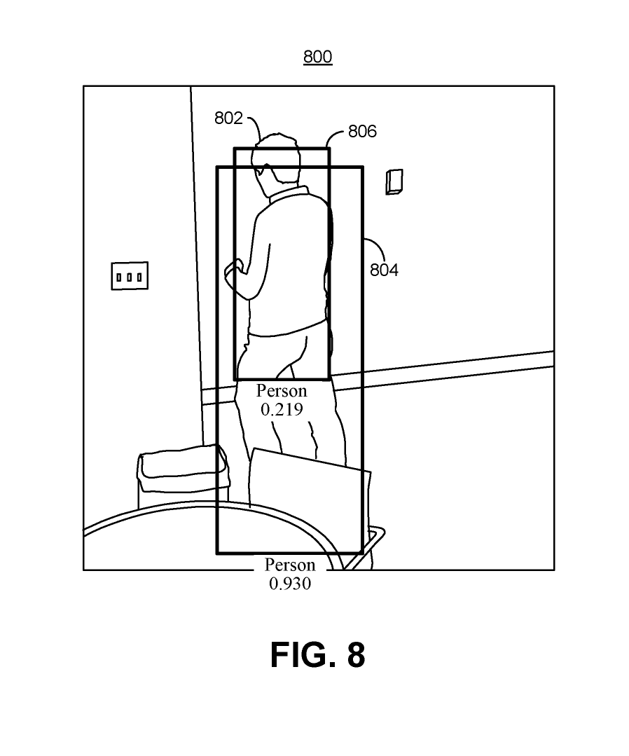

Other issues are also present with deep learning based complex detectors. For example, many kinds of objects are detected by deep learning detectors, but some of the detected objects might not be interesting for the video analytics system and thus should not be reported as detected events. Such objects may be considered as false positives. For example, if a portrait is present in the scene, a video analytics system would not want to indicate an event (e.g. an alert) that such an object is present. An example of false positive detection is illustrated by the video frame 800 shown in FIG. 8. As shown, two bounding boxes 804 and 806 are detected for the person 802. The bounding box 806 is detected for the person 802 with a low confidence value, while the bounding box 804 is detected with a high confidence value. Deep learning based solutions are also limited to the object categories that the network is trained for. As a result, an object that is not part of the trained network can go un-detected.

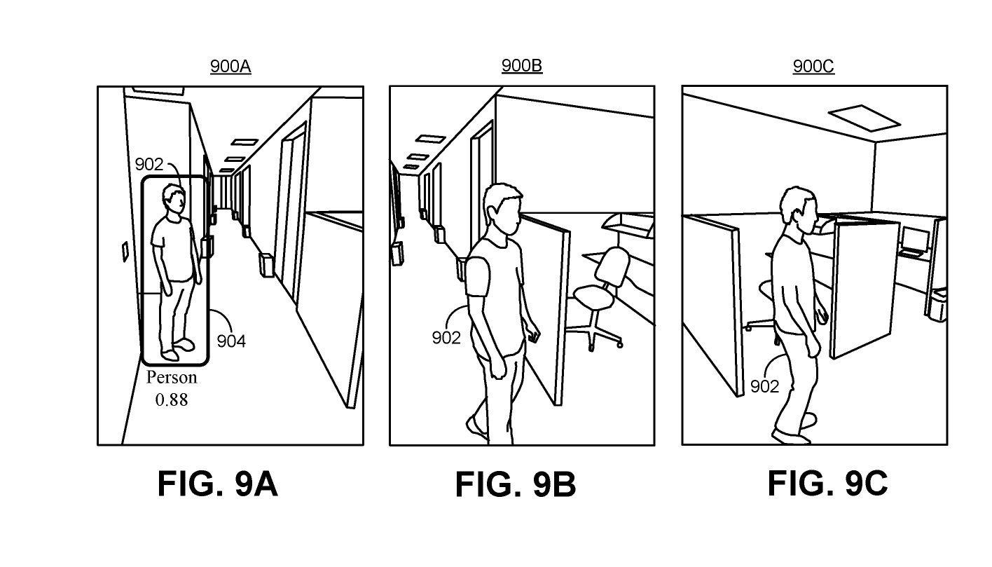

Furthermore, even through deep learning based complex detectors are quite slow, such detectors may be used for tracking. However, such a tracking system offers good performance only under the situation of very small motion or a relatively static scene (objects within it have very little or no motion). For instance, whenever a person is moving with a normal speed in a scene, the person cannot be detected by a deep learning based detector. FIG. 9A-FIG. 9C show an example of a person 902 moving within a scene. As shown in the frame 900A of FIG. 9A, the person 902 is standing still, in which case the person is detected with confidence (illustrated by bounding box 904, a “person” class, and a confidence level or value of 0.88) by a deep learning based detector. However, when the person 902 is walking with normal speed, as shown in the frame 900B of FIG. 9B and the frame 900C of FIG. 9C, the person is not detected at all. Such a lack of detection is based on the latency required to detect an object being greater than real-time. For example, it may take at least a half second or more to detect an object using a deep learning network, in which case the person cannot be classified at each frame of the video sequence capturing the person.

Deep learning based detect objection approaches are also sensitive to object features. If key object characteristics can be hidden (e.g., facial landmarks such as eyes, nose, mouth, or the like in a deep learning-based face detector), the objects might go un-detected.

In order to improve the object detection and tracking accuracy in motion-based video analytics systems, a hybrid video analytics system is provided herein that is based on the synergistic use of motion-based video analytics and complex object detection (e.g., full-frame or region-of-interest based) and that provides bounding regions of relevant objects. The complex object detection can be based on application of a trained classification network (e.g., a deep learning network) to classify and localize the relevant objects. Unlike detectors such as the Aggregate Channel Features (ACF) detector, which is relatively easy to implement in real-time (e.g., at a frame rate of 30 frames per second (fps)), the deep learning networks applied by the video analytics system discussed herein provide object detection with a much higher accuracy, but at the cost of large latencies when executed independently (even for a small input image resolution). By applying a combined video analytics object detection/tracking system and a complex object detection system, the problems described above can be avoided. For example, the video analytics system described herein provides object detection and tracking with high-accuracy, while achieving real-time performance without such latencies. Such high-accuracy, real-time performance can even be achieved by a device (e.g., an IP camera or other device) that does not have a graphics card.

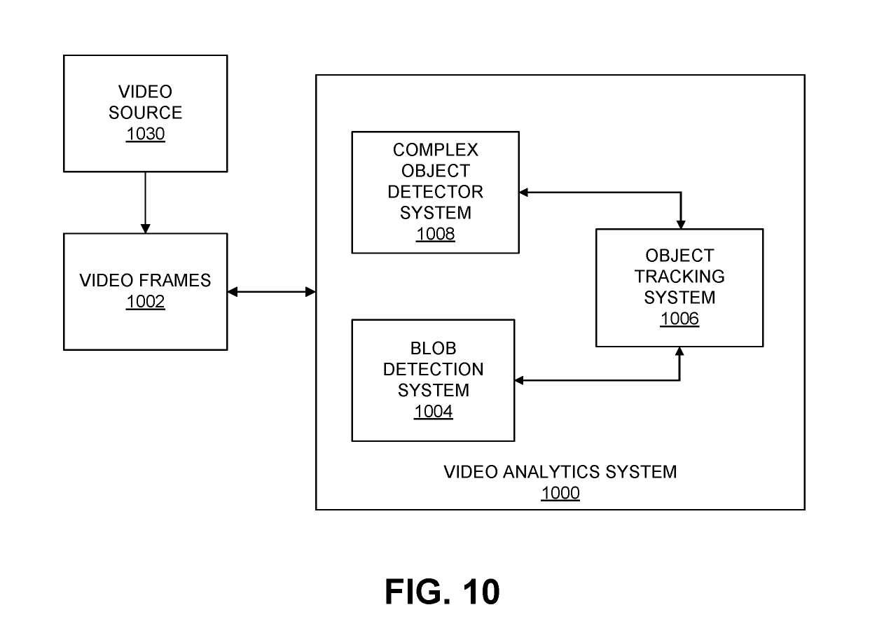

FIG. 10 is an example of a hybrid video analytics system 1000 that can be used to perform object detection and tracking in real-time using deep learning. The hybrid video analytics system 1000 performs complex, multiple source object detection to detect and track objects in images with high-accuracy and in real-time. The multiple source object detection is achieved by combining blob detection and complex object detection (e.g., using a trained classification network). As used herein, the term “real-time” refers to detecting and tracking objects in a video sequence as the video sequence is being captured. The video analytics system 1000 includes a blob detection system 1004, an object tracking system 1006, and a complex object detector system 1008. The blob detection system 1004 is similar to and can perform the same operations as the blob detection system 104 described above with respect to FIG. 1-FIG. 4. For example, the blob detection system 1004 can receive video frames 1002 of a video sequence provided by a video source 1030. The blob detection system 1004 can perform object detection to detect one or more blobs (representing one or more objects) for the video frames 1002. Blob bounding boxes associated with the blobs are generated by the blob detection system 1004. The blobs and/or the blob bounding boxes can be output for further processing by the video analytics system 1000. While examples are described herein using bounding boxes as examples of bounding regions, one of ordinary skill will appreciate that any other suitable bounding region could be used instead of bounding boxes, such as bounding circles, bounding ellipses, or any other suitably-shaped regions representing trackers, blobs, and/or objects.

The complex object detector system 1008 can implement a complex object detector. For example, the complex object detector can be implemented using one or more trained neural network (e.g., a deep learning network) to one or more of the frames 1002 of the received video sequence to locate and classify objects in the one or more frames. An output of the complex object detector system 1008 can include a set of detector bounding boxes (also referred to as high confidence bounding boxes) representing the detected and classified objects. Examples of trained neural networks that can be applied by the complex object detector system 1008 can include an SSD detector (described below with respect to FIG. 17A-FIG. 17C), a YOLO detector (described below with respect to FIG. 18A-FIG. 18C), or any other suitable neural network. Various other neural networks that can be applied by the complex object detector system 1208 are described below with respect to FIG. 15 and FIG. 16.

A trained neural network applied by the complex object detector system 1008 can generate and output classifications and confidence levels (also referred to as confidence values) for each object detected in a key frame, similar to the classifications and confidence levels shown in FIG. 8 (the object classified as a person with a 93% confidence using bounding box 804). A classification and confidence level determined for an object can be associated with the bounding box determined for the object. For instance, the deep learning network applied by the complex object detector system 1008 may provide a list of detector bounding boxes for a key frame, along with a category classification and a confidence level (CL) associated with each detector bounding box. The object classification indicates a category determined for an object detected in a key frame using the deep learning classification network. Any number of classes or categories can be determined for an object, such as a person, a car, or other suitable object class that the deep network is configured to detect and classify. The one or more classes the deep network is configured to identify are application dependent and can be made configurable as part of the video analytics system 1000. The confidence level for an object indicates a likelihood (e.g., as a probability or other suitable representation of likelihood) that the object is of a particular category. For instance, the example shown in FIG. 8 illustrates that the detector applied to the frame 800 indicated a probability of 93% (0.930) that the object detected using bounding box 804 in the frame 800 is a “person” class.

A final set of bounding boxes can be determined using detector bounding boxes produced by the complex object detector system 1008 and blob bounding boxes produced by the blob detection system 1004. For example, the blob bounding boxes (generated by the blob detection system 1004) and the detector bounding boxes (generated by the complex object detector system 1008) can be generated for a same video frame, and can be analyzed to determine a final set of bounding boxes for the video frame. A status can also be determined for each of the bounding boxes in the final set of bounding boxes. Each of the bounding boxes in the final set can represent a blob detected for the video frame.

The final set of bounding boxes determined for a video frame (representing blobs in the video frame) can be provided, for example, for blob processing, object tracking, and other video analytics functions. For example, final bounding boxes can be provided to the object tracking system 1006, which can perform object tracking to track the detected blobs and the objects represented by the blobs. The object tracking system 1006 is similar to and can perform the same operations as the object tracking system 106 described above with respect to FIG. 1-FIG. 4. As described above, the object tracking system 1006 can associate trackers and their bounding boxes with the one or more blobs (using the blob bounding boxes) detected by the blob detection system 1004. A tracker bounding box can then be displayed as tracking a tracked object/blob when certain conditions are met (e.g., the blob has been tracked for a certain number of frames, a certain period of time, and/or other suitable conditions).

The video analytics system can also include a video analytics manager. The video analytics manager can record object detection and tracking events based on information from the object tracking system 1006. For example, a state machine ran by the object tracking system 1006 can update the states of the various trackers, and can provide the states to the video analytics manager. The video analytics manager can maintain metadata for each of the trackers and their bounding boxes. The object tracking system 1006 can also predict the tracker positions for a next frame based on the positions of the blob for which the trackers are associated, as described above with respect to FIG. 1-FIG. 4. In one illustrative example, the object tracking system 1006 can implement a Kalman filter to predict the tracker positions. However, other tracking methods can also be performed, including optical flow, template matching, meanshift, camshift, and/or other suitable tracking methods.

In some cases, the video analytics system 1000 can perform background subtraction-based object detection and tracking at every video frame of the received video sequence to detect and track objects in the frames (using the techniques described above with respect to FIG. 1-FIG. 4). In some implementations, the background subtraction-based object detection and tracking may not be performed for every video frame of the video sequence. For example, object detection and tracking may be performed for every other video frame or for some other suitable number of video frames.

In some cases, the complex object detector system 1008 can apply a deep learning network to only a subset of frames of the received video sequence. For instance, the complex object detector system 1008 can apply the deep learning network every N frames, with N being determined based on the delay required to process a frame using the deep learning network and the frame rate of the video sequence. In one illustrative example, the processing time for the complex object detector system 1008 to apply the trained neural network to a frame is denoted as T_{d}, and assuming the system frame rate is fr, the high complexity detector can be applied once every N=ceil(T_{d}*fr) frames. Each frame for which both blob detection and a deep learning network is applied is referred to herein as a key frame. For other frames (referred to as non-key frames), blob detection is applied without also applying the deep learning network. Accordingly, when the complex object detector system 1008 is used, it applies to key frames and not to the remaining non-key frames. If an object has never been detected or identified by the complex object detector system 1008, only background subtraction is used to detect and track such an object and the tracker associated with the object is denoted as a normal confidence tracker. However, once the object is detected by the complex object detector system 1008 in a key frame, its associated tracker is denoted as a high confidence tracker.

A hybrid video analytics system (such as video analytics system 1000) can encounter problems for slow or still objects. For example, as noted previously, object detection based on deep learning or other neural network-based detection may be done at a very low frequency (e.g., every N frames), and tracking (and detection) for a majority of the frames can still be based on background subtraction. However, for slow and still objects, the associated blobs for such objects may become very small or even empty. For example, as discussed above with respect to FIG. 7, the background subtraction component of the blob detection system 1004 can encounter issues when dealing with still objects. A still or static object is an object that is moving through a scene and that eventually becomes stationary or begins to move slowly. In one illustrative example, a car can enter a scene by driving into a parking lot and can then park in a parking spot. Once the car parks, it can become a still (or static) object.

A blob and the object represented by the blob can be detected and tracked based on background subtraction, as long as the object is in motion. However, once the object stops or slows down and becomes a still object, the background subtraction model will transition the pixels of the object from foreground pixels to background pixels due to the nature of background subtraction adapting to local changes quickly. For example, a background subtraction process based on GMM or other statistical learning model adapts to the local changes for each pixel. Once a moving object stops or slows down, for each pixel location making up the object, the same pixel value (due to the pixel value for that location not changing) continues contributing to the associated background model, causing the region associated with the object to become background. Once the pixels making up the object are detected as background by the background subtraction process, the object and its blob fade into the background and can no longer be detected and tracked. A still object thus will not be detected and tracking of the object will be lost for a simple background subtraction based solution. In such cases, an object may disappear and/or reappear with a similar a different label.

In some cases, a low complexity sleeping object detection method can be used by a background-subtraction based video analytics system to detect still objects. In such a method, an appearance model together with the target sleeping bounding box of a tracker is maintained and updated periodically. Once there is a clear sign that the object is being absorbed into the background, a target sleeping bounding box (instead of the current bounding box) is used to re-calculate the appearance model of the current frame within the target sleeping bounding box, which is compared with a maintained appearance model. If the comparison determines that, in addition, the texture is also unchanged, a sleeping object is detected. In order to determine the clear sign of object being absorbed into the background, an object vanishing process is performed, which identifies a history of bounding boxes that continue to shrink from frame to frame. However, in some cases (e.g., for close distance objects, among other situations), the low complexity sleeping object detection may not work for still objects. For example, the vanishing process cannot be identified for close, yet still objects, since any small movement exhibited by any part of the object may lead to failures in the vanishing process detection.

Methods and systems are described herein for detecting still trackers (and thus still objects) in a hybrid video analytics system. For example, the hybrid video analytics system 1000 can detect still trackers and associated objects (e.g., that are still or slow moving) based on key frame detection results. The key frame detection results can be applied to determine whether a current object (and the tracker associated with the object) is a still object in various situations. The complex object detector system 1008 is applied to key frames to detect objects in the key frames. As noted previously, once an object is detected by the complex object detector system 1008 in a key frame, its associated tracker is denoted as a high confidence tracker. The complex object detector system 1008 generates bounding boxes for the high confidence trackers (and the detected objects). Such bounding boxes generated for key frames are referred to herein as key frame bounding boxes or key bounding boxes (key BBs), and are similar to the detector bounding boxes (or high confidence bounding boxes) described above. By using the key frame detection results, a slow or still object can be detected for non-key frames, allowing tracking of such still objects to be performed more smoothly and providing temporally consistent tracking results.

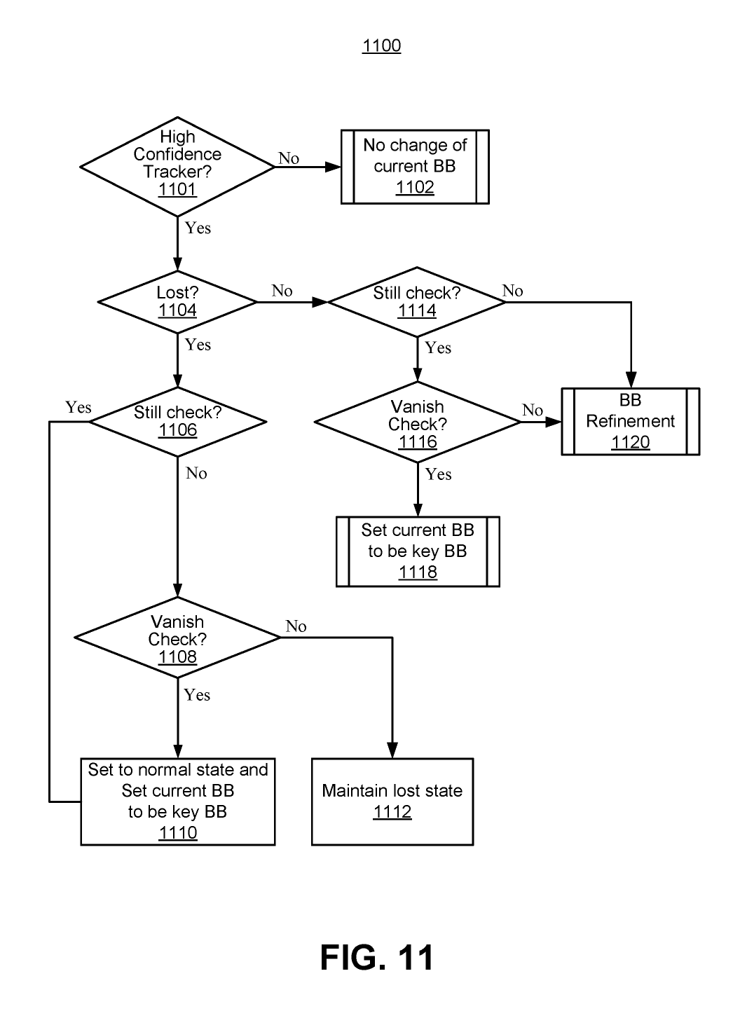

FIG. 11 is a flowchart illustrating an example of a process 1100 for processing trackers (and associated objects) using the video analytics system 1000. The process 1100 can be used to determine whether a tracker is a still or slow moving tracker, and/or to determine whether to refine a bounding box for a tracker. The process 1100 is performed at each video frame of a sequence of video frames and for each tracker maintained for the sequence of video frames. In some cases, the process 1100 can be performed after the tracking process is performed (after cost determination and data association are performed) and before outputting a tracker. For example, the process 1100 can be performed by the object tracking system 1006, the video analytics manager, or other suitable component of the video analytics system 1000. A tracker currently being processed by the process 1100 is referred to herein as a current tracker.

At block 1101, the process 1100 determines whether a current tracker is a high confidence tracker. For example, if an object the tracker is tracking has been detected by the complex object detector system 1008 in at least one key frame of the video sequence, the tracker is marked as a high confidence tracker. In some cases, a high confidence tracker state can be maintained (e.g., as metadata) for the tracker in the tracker's history. The operations performed by the process 1100 have no impact for a normal confidence tracker. For example, if a current tracker is not determined to be a high confidence tracker (has not been detected before by the complex object detector system 1008) at block 1101, and thus is a normal confidence tracker, the process 1100 makes no change to the current bounding box of the tracker at block 1102.

In some cases, when a high confidence tracker is lost and it has been detected as tracking a still object (and is thus a still or static tracker), instead of detecting it as a lost tracker and not outputting any bounding box for the current frame, the process 1100 can set the bounding box of the lost tracker to be available and can change the tracker's bounding box to be equal to the bounding box from the latest (most recent) key frame for which the complex object detector system 1008 detected a high confidence bounding box for the object being tracked by the tracker. As noted previously, the bounding box from the latest key frame is denoted as a key bounding box (key BB).

For example, at block 1104, the process 1100 can determine whether the current tracker is a lost tracker. A tracker can be determined to be lost in a frame when background subtraction-based object detection and tracking is performed for the frame. For example, as described above, a tracker is considered to be lost when the tracker is not associated with any foreground blob in a current frame by the data association engine 414. A lost tracker that is assigned a lost state may not have its bounding box output (e.g., for display) in the current frame. However, the process 1100 can cause the video analytics system 1000 (e.g., the object tracking system 1006, the video analytics manager, or other suitable component) to output the bounding box of the lost tracker (e.g., for display) when the tracker is detected as being still. For example, if the current tracker is determined to be lost at block 1104, the process 1100, at block 1106, can determine whether the current tracker is a still tracker (associated with a still object) having a still status. The video analytics system 1000 can determine whether the current tracker is a still tracker based on a maintained state of the tracker, as described in more detail below. If the current tracker is determined to be a still tracker (e.g., based on the tracker determining to have a still status or state) at block 1106, the process 1100, at block 1110, sets the state of the current tracker to a normal state and sets the current bounding box of the tracker to be the key BB (from the most recent key frame for which a key bounding box has been detected for the object). The current bounding box of the tracker is thus replaced with the key BB. As described in more detail below, a tracker and the associated object can be detected as being still (and given a still tracker state) using a still tracker detection process that is applied for the tracker at key frames.

In some cases, when a high confidence tracker is lost and, based on a vanishing status check process applied to the tracker, it is confirmed that the tracker has vanishing bounding boxes (e.g., associated with one or more blobs that are being detected as background), instead of still detecting the tracker as a lost tracker and not outputting any bounding box for the tracker for the current frame, the bounding box of the lost tracker can be set to be available and be made a key bounding box. For example, if the process 1100, at block 1104, determines the current tracker is a lost tracker, and determines, at block 1106, that the current tracker is not a still tracker, the process 1100 can perform a vanishing status check to determine if the current tracker has a history of vanishing bounding boxes. The vanishing status check is described in more detail below. If the vanishing status check succeeds for the current tracker (it is determined to have vanishing bounding boxes), the process 1100, at block 1110, sets the state of the current tracker to a normal state and sets the current bounding box of the tracker to be the key BB. In the event the vanishing status check fails for the current bounding box (the tracker's bounding boxes are not considered to be vanishing), the process 1100, at block 1112, maintains or keeps the tracker in the lost state.

In some cases, when a high confidence tracker is not lost, but the tracker has been detected as a still tracker (associated with a still object) and it has been confirmed to have vanishing bounding boxes, instead of using the current detected bounding box to represent the current object, the key BB is used. For example, if the process 1100, at block 1104, determines the current tracker is not a lost tracker, the process determines, at block 1114, whether the current tracker is a still tracker (e.g., having a still status). The still check at block 1114 is the same as the still check at block 1106. If the current tracker is determined to be a still tracker at block 1114, the process 1100 can perform a vanishing status check at block 1116 to determine if the current tracker has a history of vanishing bounding boxes. The vanishing status check at block 1116 is the same as the vanishing status check at block 1108. If the vanishing status check succeeds for the current tracker (it is determined to have vanishing bounding boxes), the process 1100, at block 1118, sets the current bounding box of the tracker to be the key BB. The current bounding box of the tracker is thus replaced with the key BB.

In some cases, when a high confidence tracker is not lost and the tracker has neither been detected as being still or vanishing, and if the current frame is not a key frame, a bounding box refinement process is applied at block 1120 to adjust the final bounding box associated with the high confidence tracker in the current frame. For example, in the event the current frame is a non-key frame, the still check at block 1114 determines the current tracker is not still, and the vanishing status check fails for the current bounding box at block 1116, the process 1100 can perform bounding box refinement at block 1120. Bounding box refinement includes determining whether to modify the current bounding box of the tracker or to set the bounding box of the tracker to a previous bounding box used by the tracker in a previous frame of the sequence of video frames. Further details of the bounding box refinement process are described below.

In some implementations, in order to properly maintain the statuses of trackers with respect to them being still or not, several key statuses can be implemented. The statuses can provide reliable detection of still trackers (and associated objects) and stable transition to the still status. An example of the proposed statuses is listed below, with each status being assigned a value (denoted in parentheses as (0), (1), (2), (3), (4), (5), and (6)) in ascending order as listed below:

TABLE 1

S_NEW_NONE (0): a tracker that was just detected (the tracker state is still
new).
S_NEW_REMOVE (1): a tracker that was confirmed to not have a high
confidence box associated.
S_NEW_SINGULAR (2): a tracker that is just confirmed to have a high
confidence box associated in the closest key frame.
S_NEW_LATER_SMOOTH (3): later smooth.
S_NEW_EARLY_SMOOTH (4): early smooth.
S_CONFIRMED_NORMAL (5): a normal high confidence tracker.
S_CONFIRMED_STATIC (6): a still high confidence tracker.

In some examples, the detection of a still tracker can include two steps: 1) to confirm the current high confidence tracker is a stable tracker; and 2) for a stable tracker, to confirm whether the current high confidence tracker is still or not. In some cases, it can be determined whether a high confidence tracker is still or not (step 2) without first determining whether the tracker is stable (without performing step 1).

In implementations in which step 1 is performed, a stable tracker detection process can be performed to confirm a current high confidence tracker is a stable tracker. By implementing the stable tracker detection process, the video analytics system 1000 can avoid triggering of still tracker detection (also referred to as still object detection) by a potential singular false positive tracker (e.g., due a false positive object being detected by the complex object detector system 1008).

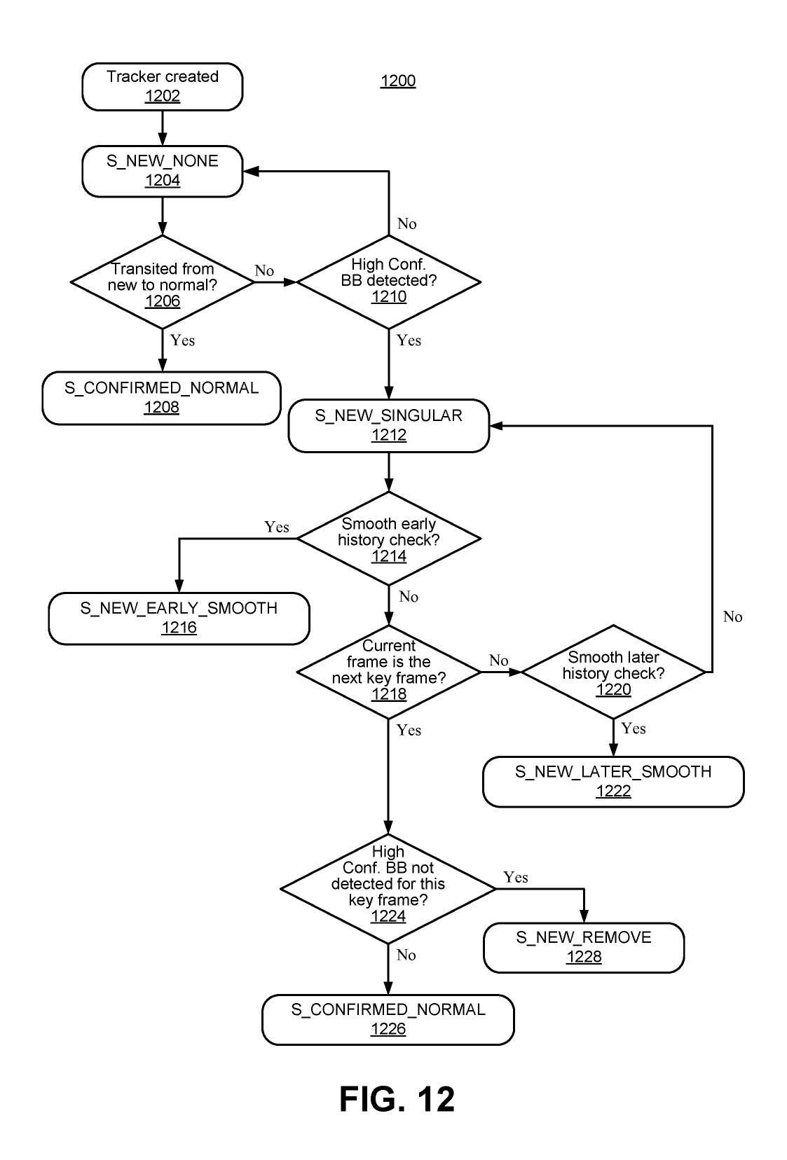

FIG. 12 is a flowchart illustrating an example of a stable tracker determination process 1200. The process 1200 is performed at each video frame of the sequence of video frames and for each tracker maintained for the sequence of video frames. The process 1200 begins at a particular step depending on the state assigned to the tracker in the current frame. For example, block 1202 can be performed for a tracker that is newly created in the current frame. For example, at block 1202, the process 1200 determines that a current tracker is newly created, and transitions the tracker to a S_NEW_NONE state at block 1204.

When the current tracker being processed is a new tracker (with a S_NEW_NONE state), the process 1200 can determine, at block 1206, whether the new tracker should be transited from the new state to a normal state. For example, as previously described, a new tracker can be transitioned from a new state to a normal state when the tracker has been continuously associated with blobs for a threshold duration. The threshold duration can be set to a certain number of frames (e.g., 30 frames, 60 frames, or other suitable number of frames) or to a certain amount of time (e.g., 1 second, 2 seconds, or other suitable amount of time). If, at block 1206, the process 1200 determines the new tracker should be transited to normal, the tracker is assigned the S_CONFIRMED_NORMAL state at block 1208. For example, when a high confidence bounding box is detected when the current tracker is already a “normal” tracker (transited from “new”), the chances of this object being a false positive is quite low and its status can be switched to the S_CONFIRMED_NORMAL status directly. As previously discussed, a normal tracker is output as an identified tracker-blob pair at the system level as an event (e.g., presented as a tracked object on a display, output as an alert, and/or other suitable event). In some cases, the status data of the normal tracker, the motion model for the normal tracker, and/or other information related to the normal tracker can be output as part of object metadata for the tracker. The metadata, including the normal tracker, can be output from the video analytics system (e.g., an IP camera running the video analytics system) to a server or other system storage. The metadata can then be analyzed for event detection (e.g., by a rule interpreter).

If, at block 1206, the process 1200 determines the new tracker should not be transited to normal, the process 1200 detects whether the new tracker is a high confidence tracker with a high confidence bounding box at block 1210. For example, the block 1210 can determine if the tracker has a high confidence box associated with it in the closest (or most recent) key frame to the current frame. As noted previously, a tracker is associated with a high confidence bounding box, and thus is a high confidence tracker, when the complex object detector system 1008 detects the object associated with the tracker in a key frame. Block 1210 can thus detect the first instance (or “singular” instance) of when the tracker is a high confidence tracker with a high confidence bounding box. If the new tracker is determined (at block 1210) not to be a high confidence tracker, in which case there is no high confidence bounding box for the tracker, the process 1200 maintains the tracker as a new tracker (with the S_NEW_NONE state) at block 1204. For example, block 1210 can determine that the new tracker was not associated with a high confidence bounding box in the most recent key frame, in which case the tracker is maintained as a new tracker.

In some cases, when a high confidence bounding box is detected before a “new” tracker (with a S_NEW_NONE state) has been turned to “normal” (with a S_CONFIRMED_NORMAL state), the status of the tracker can be transitioned from the new state (S_NEW_NONE) to a singular state (S_NEW_SINGULAR). For example, if the new tracker is determined, at block 1210, to be a high confidence tracker, and thus a high confidence bounding box is detected for the tracker, the process 1200 transitions the tracker from the new state (S_NEW_NONE) to the singular state (S_NEW_SINGULAR). For example, the process can determine, at block 1210, that the new tracker was associated with a high confidence bounding box in the most recent key frame, and the new tracker can be transitioned to the singular state. When the current tracker has the singular status of S_NEW_SINGULAR, the tracker is not output (e.g., as an event to the system).

When a tracker has the singular status of S_NEW_SINGULAR, the “early history” and “later history” of the tracker may be checked to further change the status of the tracker. A tracker can have the singular status for multiple frames, in which case the smooth early history check (block 1214) and the smooth later history check (block 1220) can be performed at each frame for which the tracker has the singular status. However, if the status of the tracker has been kept as S_NEW_SINGULAR when a next key frame is received, the status is either changed to S_CONFIRMED_NORMAL (when a high confidence bounding box is again detected for the tracker in the next key frame) or to S_NEW_REMOVE (when a high confidence bounding box is not detected again for the tracker in the next key frame). This sub-process of the process 1200 can be referred to herein as singular status detection.

The singular status detection process is performed by blocks 1212-1228 of process 1200. For example, the process 1200 can perform a smooth early history check at block 1214 for a current tracker that has the singular state of S_NEW_SINGULAR. For example, the early history of the tracker can include the bounding boxes of the tracker detected using the background subtraction based blob detection and tracking from the frame at which the tracker was created to the frame at which the object associated with the tracker is detected by the complex object detector system 1008, which is when the tracker becomes a high confidence tracker and is associated with a high confidence bounding box. The smooth early history check includes checking the bounding box history of the tracker from when the tracker was created to when the object associated with the tracker is detected by the complex object detector system 1008. If the early history of bounding box is smooth, the current tracker may be considered not in the singular status anymore and may be transited to the still status. The number of bounding boxes in the tracker's early history can be compared to an early history threshold T number of bounding boxes to determine if the tracker passes the early history check. For example, the smooth early history check can pass for the tracker if the history from the tracker's creation to the tracker being detected by the complex object detector system 1008 (at which point the tracker is associated with a high confidence bounding box) is larger than the early history threshold T. If the smooth early history check passes for the tracker, the tracker's status is set to the S_NEW_EARLY_SMOOTH status at block 1216. For example, when the early history of the tracker is determined to be smooth at block 1214, the tracker can be transitioned to the S_NEW_EARLY_SMOOTH status at block 1216, making the tracker eligible for transition to the still status based on the analysis of the tracker by the still tracker detection process (described below).

The early history threshold T can be set to any suitable number. For example, the value set for the early history threshold T can be defined to ensure the tracker and its bounding boxes are stable (and the tracker is not a false positive). In one illustrative example, the threshold T can be set to the estimated number of frames to wait for each trained neural network based object detection to be invoked. For instance, if the complex object detector system 1008 applies the trained deep learning network every N frames (e.g., with N being determined based on the delay required to process a frame using the deep learning network and the frame rate of the video sequence), the early history threshold T can be set to the number N. In such an example, the smooth early history of the tracker would need to include at least N bounding boxes (or greater than N bounding boxes) for the tracker to pass the smooth early history check.

If the tracker does not pass the smooth early history check at block 1214, the process 1200 determines whether the current frame is the next key frame at block 1218. If the current frame is not the next key frame (in which case the current frame is a non-key frame), the process 1200 performs a smooth later history check at block 1220. The later history smooth check applies to every frame until the next key frame (determined at block 1224). For each current frame, the later history of a tracker is defined as starting from the frame when the high confidence bounding box was detected, until the current frame. For example, the later history of the tracker can include the bounding boxes of the tracker detected using the background subtraction based blob detection and tracking from the frame at which the object associated with the tracker was detected by the complex object detector system 1008 (when the tracker became a high confidence tracker and is associated with a high confidence bounding box) until the current frame.

The smooth later history check includes checking the bounding box history of the tracker from when the object associated with the tracker is detected by the complex object detector system 1008 to the current frame. For example, whether the tracker passes the smooth later history check can be based on the number bounding boxes in the later history and/or based on sizes of the bounding boxes in the tracker's later history. In one illustrative example, when one or both of two conditions are true, the status of the tracker can be transited to the S_NEW_LATER_SMOOTH status. The first condition that can cause the tracker to pass the smooth later history check can include when the duration of the later history is longer than a later history threshold T1 number of bounding boxes. The value set for the later history threshold T1 can be defined to ensure the tracker and its bounding boxes are stable (and the tracker is not a false positive). In one illustrative example, the later history threshold can be set equal to T/2. The second condition that can cause the tracker to pass the smooth later history check can include when the size of any bounding box in the later history of the tracker is larger than a threshold size of the key bounding region of the tracker in the most recent key frame. For example, when a size of any bounding box from the tracker's later history is greater than R*size(key bounding box), the tracker passes the later history check. The threshold size R may be set to any suitable value. In one illustrative example, R may be set to 0.25.

If the later history of bounding boxes for the tracker is determined to be smooth at block 1220, the current tracker may be considered not in the singular status anymore and may be transited to the still status. For example, when the later history of the tracker is determined to be smooth at block 1220, the tracker can be transitioned to the S_NEW_LATER_SMOOTH status at block 1222, making the tracker eligible for transition to the still status based on the analysis of the tracker by the still tracker detection process (described below).

As noted previously, if the status of the tracker has been kept as S_NEW_SINGULAR when a next key frame is obtained, the status of the tracker can be transitioned either to the S_CONFIRMED_NORMAL status or to the S_NEW_REMOVE status. For example, at block 1218, the process 1200 can determine whether a current frame is a next key frame in the video sequence (at which point the complex object detector system 1008 will be applied). If the current frame is a next key frame, the process 1200 checks whether a high confidence bounding box is detected for the tracker in the key frame by the complex object detector system 1008. When a high confidence bounding box is again detected for the tracker in the next key frame, the status of the tracker is transitioned to the S_CONFIRMED_NORMAL status at block 1226. When a high confidence bounding box is not detected again for the tracker in the next key frame, the status of the tracker is transitioned to the S_NEW_REMOVE status at block 1228.

In some cases, different statuses than those denoted above can be used. For example, the statuses can be simplified. In one example, the S_NEW_REMOVE and S_NEW_NONE statuses may be merged to one status. In another example, the S_NEW_LATER_SMOOTH and S_NEW_EARLY_SMOOTH statuses may be both merged into a S_NEW_NORMAL_CONFIRMED status.

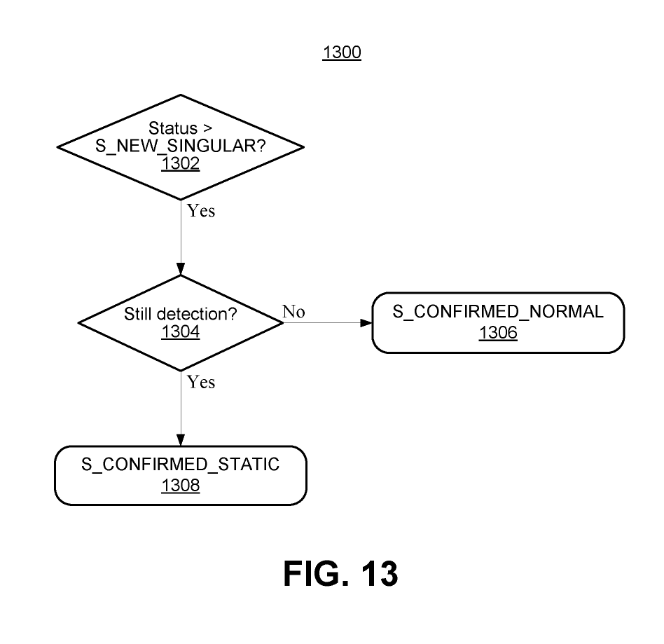

After the singular status detection sub-process is performed for a current tracker, a still tracker detection process can be applied to determine whether to convert the status of the current tracker to a still status (denoted as S_CONFIRMED_STATIC). FIG. 13 is a flowchart illustrating an example of a process 1300 for determining a still tracker. At block 1302, the process 1300 includes determining whether the status of a current tracker is greater than the singular (S_NEW_SINGULAR) status. For example, the still tracker detection process 1300 can be applied, in some implementations, only when a tracker has a status not equal to S_NEW_NONE, S_NEW_REMOVE or S_NEW_SINGULAR. In such an example, the still tracker detection process 1300 is applied to a tracker only when the tracker has a status of S_NEW_LATER_SMOOTH, S_NEW_EARLY_SMOOTH, S_CONFIRMED_NORMAL, or S_CONFIRMED_STATIC. In some examples, block 1302 can determine whether the status of a tracker is greater than the singular status by checking whether the status value of the tracker is greater than the singular status value. An example of the values assigned to the different statuses is shown in Table 1 above. For example, each of the S_NEW_LATER_SMOOTH, S_NEW_EARLY_SMOOTH, S_CONFIRMED_NORMAL, and the S_CONFIRMED_STATIC statuses have an assigned value that is greater than the S_NEW_SINGULAR status. Such values can be used by the process 1300 to determine whether the status value of the current tracker is greater than the singular status. For example, any tracker that has the new later smooth status, the new early smooth status, the confirmed normal status, the confirmed static status, or the merged new normal confirmed status (merging the new early smooth and new later smooth statuses) will have a status greater than the singular status.

If, at block 1302, the process 1300 determines the status of the current tracker is greater than the singular status, the process 1300 performs the still tracker detection at block 1304 to determine whether the current tracker is a still tracker (and thus whether the object associated with the tracker is a still object) and should be updated to a still status. In some cases, the still tracker detection process applies for a tracker only when the current frame is a key frame. For example, in such cases, a tracker can be converted to a still object only in a key frame. In some cases, the still tracker detection process can be applied for the tracker in non-key frames.

A key frame bounding box list can be maintained for each tracker. The key frame bounding box list of a tracker can be used in the still detection process. The key frame bounding box list can include multiple items (or entries), with each item in the list being associated with a key frame. Each item in the key frame bounding box list can include a bounding box detected in a key frame, as well as the frame difference (frame_dis) between the current frame and the key frame when the bounding box was detected. If, for a given key frame, the object was not detected by the complex object detector system 1008 (the high confidence tracker and bounding box was not available in that key frame), the bounding box for that item can be set to empty, but is kept in the list. The list can initially be set to empty for a tracker. For any given frame, each tracker's list is updated after the current bounding box for each tracker has been determined. If the current frame is not a key frame, the frame_dis of each entry is increased by 1. If the current frame is a key frame, a new item or entry is added to the list for a tracker, with the new item including the current bounding box detected in the key frame for the tracker (or, if no object is detected for the tracker, an empty bounding box) and the frame_dis equal to 0.

The still tracker detection process can be based on various factors. For example, a tracker (and its associated object) can be determined to be a still tracker based on a number of entries in a tracker's key frame bounding box list, based on whether any entries in the tracker's key frame bounding box list is empty, based on a spatial relationship between two key frame bounding boxes in the tracker's key frame bounding box list, based on a key frame distance range, any combination thereof, and/or based on any other suitable factors.

In some examples, the still tracker detection process can determine whether a tracker (and its associated object) is a still tracker or not based on a number of entries in the key frame bounding box list of the tracker. For example, a tracker may be removed from consideration as a still tracker in a current key frame (or non-key frame in some cases) when the number of entries in the tracker's key frame bounding box list is too low. A reason for removing the tracker from consideration in such instances is that background subtraction may take a certain amount of time (e.g., 2 seconds, 3 seconds, or other amount of time) to stop detecting a still or slowly moving object as foreground (due to the object being detected as background), which corresponds to a certain number of key frames. The still detection process may want to wait until a certain number of key frames have been processed before considering whether a tracker is a still tracker, in order to give the background subtraction based blob detector to detect a still or slowly moving object into the background.

For example, when the number of entries in the key frame bounding box list of the tracker is less than a threshold number of entries, the still detection process can terminate and the current status of the tracker can be set to the S_CONFIRMED_NORMAL status. In such an example, the tracker is removed from consideration as a still tracker in a current key frame (or non-key frame in some cases) when the number of entries in the tracker's key frame bounding box list is too low. If the number of entries in the tracker's key frame bounding box list is above the threshold number of entries, the tracker's key frame bounding box list can be further analyzed to determine if the tracker should be transitioned to a still tracker. The threshold number of entries can be set to any suitable value, which can indicate a suitable number of key frames that are needed to consider a tracker as a still tracker. The threshold can be based on the frequency of key frames, which may occur, for example, every half second, every 0.75 seconds, or other suitable frequency.

In some examples, the still tracker detection process can determine whether a tracker (and its associated object) is a still tracker or not based on whether any entries in the tracker's key frame bounding box list is empty. For example, a tracker may be removed from consideration as a still tracker in a current key frame (or non-key frame in some cases) when one or more of the key frame bounding boxes in the tracker's key frame bounding box list is empty. A reason for removing the tracker from consideration in such instances is that, if the complex object detector system 1008 detects an object (and its bounding box) in one key frame, and the bounding box is still in the next key frame, the complex object detector system 1008 should be able to detect the object with a similar confidence score in the next key frame.

For example, when one or more of the key frame bounding boxes in the tracker's key frame bounding box list is determined to be empty (not detected), the still detection process can terminate and the current status of the tracker can be set to the S_CONFIRMED_NORMAL status. In one illustrative example, the current status of the tracker can be set to the S_CONFIRMED_NORMAL status when any of the latest key frame bounding boxes is empty. For instance, if any of the key frame bounding boxes in the list from the most recent two, three, four, or other suitable number of recent key frames is empty, the tracker can be set to the S_CONFIRMED_NORMAL status. If none of the relevant key frame bounding boxes from the tracker's key frame bounding box list is empty, the tracker's key frame bounding box list can be further analyzed to determine if the tracker should be transitioned to a still tracker.

In some examples, the still tracker detection process can determine whether a tracker (and its associated object) is a still tracker or not based on a spatial relationship between two key frame bounding boxes in the tracker's key frame bounding box list. For example, a tracker may be transitioned to have the still status in a current key frame (or non-key frame in some cases) when the spatial relationship between two bounding boxes from the key frame bounding box list is larger than the spatial threshold. For instance, a large spatial relationship demonstrates that the two bounding boxes have remained relatively still, which is indicative of a still tracker (and object).

One example of a spatial relationship is an intersection-over-union (IoU). FIG. 14 is a diagram showing an example of an intersection I and union U of two bounding boxes, including bounding box BB_{A} 1402 of the blob tracker in the current frame and bounding box BB_{B} 1404 of the blob tracker in the previous frame. The intersecting region 1408 includes the overlapped region between the bounding box BB_{A} 1402 and the bounding box BB_{B} 1404. The union region 1406 includes the union of bounding box BB_{A} 1402 and bounding box BB_{B} 1404. The union of bounding box BB_{A} 1402 and bounding box BB_{B} 1404 is defined to use the far corners of the two bounding boxes to create a new union bounding box 1410 (shown as a dotted line). More specifically, by representing each bounding box with (x, y, w, h), where (x, y) is the upper-left coordinate of a bounding box, w and h are the width and height of the bounding box, respectively, the union of the bounding boxes would be represented as follows:

Union(BB₁,BB₂)=(min(x₁,x₂),min(y₁,y₂),(max(x₁+w₁−1,x₂+w₂−1)−min(x₁,x₂)),(max(y₁+h₁−1,y₂+h₂−1)−min(y₁,y₂)))

The IoU of the two bounding boxes 1402 and 1404 can include an overlapping area between the first bounding box 1402 and the second bounding box 1404 (the intersecting region 1408) divided by the union bounding box 1410 of the bounding boxes 1402 and 1404 (denoted as

$$IoU = \frac{Area of Interesting Region 1408}{Area of Union 1410} ) .$$

Using IoU as an example of the spatial relationship, when the IoU of the two latest key frame bounding boxes is larger than a spatial threshold T2, the still detection process can terminate, and the current status of the tracker can be set to the still (or static) state (denoted as S_CONFIRMED_STATIC). The spatial threshold T2 can be set to any suitable value, such as 0.70, 0.75, 0.8, 0.85, or other suitable value.

In some examples, the still tracker detection process can determine whether a tracker (and its associated object) is a still tracker or not based on movement of bounding boxes in a key frame distance range. For example, the movement of the tracker's bounding boxes should be small for the tracker to be detected as a still tracker. The key frame distance range can be defined to include a range of minR through maxR, inclusive. The maxR can be set to a relatively large value (e.g., 7 or other suitable vlaue) and the minR can be set to a lower value (e.g., 2 or 3, or other suitable value, depending on whether the current status is S_CONFIRMED_STATIC or not).

The still tracker detection process can check all the key frame bounding boxes within the range of minR and maxR (e.g., 2 to 7). In some cases, if the number of entries is less than minR, the still detection process can terminate with the current status of the tracker being set to S_CONFIRMED_NORMAL. In some cases, if any i-th entry (with i ranging from minR to maxR, inclusive) has an empty bounding box (not detected), the still detection process can terminate with the current status of the tracker being set to S_CONFIRMED_NORMAL.

The process can then check the movement between the i-th entry and the i+1-th entry, with i being equal to minR, through maxR-1, inclusive. If an amount of movement (e.g., horizontal movement, vertical movement, both horizontal movement and vertical movement, or other movement) is less than a movement threshold, the still tracker detection process can terminate with the current status of the tracker being set to S_CONFIRMED_STATIC. In one illustrative example, if both the horizontal movement and vertical movement is less than T3 of the width and height of the i-th key BB, the still detection process can terminate and can set the current status of the tracker to the S_CONFIRMED_STATIC status. In this example, the threshold T3 can be set to any suitable value (e.g., 0.1, 0.2, or other suitable value).

In one illustrative example, the still tracker detection process can include the following steps:
(a) When the number of entries in the key frame bounding box (BB) list is less than 2, the still detection process terminates and the current status is set to S_CONFIRMED_NORMAL.
(b) In addition, when any of the latest key frame BB is empty (not detected), still detection process terminates and the current status is set to S_CONFIRMED_NORMAL.
(c) When the IoU of the two latest key frame BBs is larger than a threshold T2 (e.g., set to 0.8), still detection process terminates with the current status being S_CONFIRMED_STATIC.
(d) Define a key frame distance range of minR through maxR, inclusive. maxR is set to a relatively large value, e.g., 7 and minR is set as e.g., 2 or 3 (depending on whether the current status is S_CONFIRMED_STATIC or not). Check all the key frame bounding boxes within the range of minR and maxR (e.g., 2 to 7).
   (i) If the number of entries is less than minR, still detection process terminates with the current status being S_CONFIRMED_NORMAL.
   (ii) If any i-th entry (i ranging from 2 to 7, inclusive) has an empty bounding box (not detected), still detection process terminates with the current status being S_CONFIRMED_NORMAL.
   (iii) Check the movement between the i-th entry and the i+l-th entry, with i being equal to minR, through maxR-1, inclusive. If both the horizontal movement and vertical movement is less than T3 of the width and height of the i-th key BB, still detection process terminates with the current status being S_CONFIRMED_STATIC. Here T3 may be set to e.g., 0.1.
(e) Set current status to S_CONFIRMED_NORMAL.

Returning to FIG. 13, if the still tracker detection, at block 1304, does not pass for the current tracker (e.g., the spatial relationship and the key frame distance range checks do not determine the tracker is a still tracker), the process 1300 sets the current status of the tracker to the S_CONFIRMED_NORMAL status at block 1306. However, if the still tracker detection passes for the current tracker, the process 1300 sets the current status of the tracker to the S_CONFIRMED_STATIC status at block 1308.

As noted previously, a vanishing status check process can be performed (e.g., at blocks 1108 and 1116 of the process 1100) to determine if a current tracker has a history of vanishing bounding boxes. In some examples, the vanishing status check process can check the history of the bounding boxes of a tracker from the previous frames until the most recent key frame. In such examples, all bounding boxes in the history are maintained for a frame. The current bounding box for each tracker is considered as the input bounding box to the vanishing status check process. The input bounding box is determined as the final bounding for each tracker by applying a bounding box aggregation process. One example of a bounding box aggregation process is described in U.S. Provisional Application No. 62/578,884, filed Oct. 30, 2017, which is hereby incorporated by reference in its entirety and for all purposes.

The length of the history can be set by a threshold L, which can be set to any suitable number. In one illustrative example, the threshold L can be set to 60 (which corresponds to approximately 2 seconds for a 30 frame per second video sequence). Each bounding box in a tracker's history is compared to a key bounding box (e.g., from the most recent key frame) associated with the tracker. For example, the bounding boxes in the history can include the foreground bounding boxes of the tracker, which are detected using the background subtraction based blob detection and tracking. If a bounding box in the tracker's history is determined to be not constrained by the key bounding box, the vanishing status check fails (e.g., a “no” decision at blocks 1108 and 1116). Otherwise, if all of the bounding boxes in the history are constrained by the key bounding box, the vanishing status check succeeds for the tracker (e.g., a “yes” decision at blocks 1108 and 1116). In one example, a bounding box is considered as constrained by a key bounding box if both its width and height are relatively small compared to the key bounding box. In another example, a bounding box is considered as constrained by a key bounding box if the bounding box largely overlaps with the key bounding box. In another example, a bounding box is considered as constrained by a key bounding box if both its width and height are relatively small compared to the key bounding box and, in addition, the bounding box largely overlaps with the key bounding box.

In some cases, whether a bounding box is constrained by a key bounding box can be determined based on the type of association (e.g., based on a bounding box aggregation process) between the tracker's foreground bounding box and the tracker's high confidence bounding box for a frame. As noted above, a bounding box aggregation process is described in U.S. Provisional Application No. 62/578,884, filed Oct. 30, 2017. In one illustrative example, if the bounding box association between the foreground bounding box and the high confidence bounding box for the associated frame is a merge, as derived using a bounding box aggregation process, the vanishing status check process can be terminated as “not constrained”.

In some cases, whether a bounding box is constrained by a key bounding box can be determined based on the dimensions of the bounding box relative to the dimensions of the key bounding box. For example, as noted above, a foreground bounding box can be considered as constrained by a key bounding box if both its width and height are relatively small compared to the key bounding box. In one illustrative example, if the width of the bounding box is larger than rw of the width of the key bounding box, and the height of the bounding box is larger than rh of the height of the key bounding box, the vanishing status check process can terminate as “not constrained.” The terms rw and rh can be set to any suitable values, such as 0.5, 0.6, 0.7, 0.8, or the like. In some cases, (rw, rh) may be set to (0.8, 0.5) once as one condition. In some cases, (rw, rh) may be set at another time to (0.5, 0.8) as a second condition.

In some cases, whether a bounding box is constrained by a key bounding box can be determined based on the amount of overlap of the bounding box with the key bounding box. For example, as noted above, a bounding box can be considered as constrained by a key bounding box if the bounding box largely overlaps with the key bounding box. In one illustrative example, if the size of the overlap bounding box (denoted as overlapSize) is smaller than rs of that of the current bounding box (denoted as currBBSize), the vanishing status check process can be terminated as “not constrained.” The term rs can be set to any suitable value, such as 0.5, 0.6, or other suitable value.

In some cases, if the area of the current bounding box that is not overlapped with the key bounding box (denoted as currBBSize−overlap Size) is larger than rks of the size of the key bounding box, the process can be terminated as “not constrained.” The term rks can be set to any suitable value, such as 0.2, 0.25, 0.3, or other suitable value.

If one or more of the above conditions are not met the vanishing status check process can be terminated as “constrained,” in which case the vanishing status check process can determine the tracker has vanishing bounding boxes.

In one illustrative example, the vanishing status check process can include the following steps:
(a) If the bounding box association between the foreground BB and the high confidence BB for the associated frame is a merge, as derived using a bounding box aggregation process, terminate the process as “not constrained.”
(b) Width of the bounding box is larger than rw of the width of key BB and height of the bounding box is larger than rh of the height of the key BB, terminate the process as not constrained. Here, (rw, rh) may be set to (0.8, 0.5) once as one condition and yet another time set to (0.5, 0.8) as a second condition.
(c) If the size of the overlap bounding box (denoted as overlapSize) is smaller than rs of that of the current bounding box (denoted as currBBSize), terminate the process as “not constrained”. Here rs may be set to e.g., 0.5.
(d) If the area of the current bounding box not overlapped (currBBSize−overlapSize) is larger than rks of the size of the key BB, terminate the process as “not constrained”. Here rks may be set to e.g., 0.25.
(e) If all the above conditions are not true, terminate the process as “constrained.”

In some cases, an object may not be detected in a key frame, even when the object is still and is detected in temporally neighboring key frames. For example, in such cases, even when the object is still, the detection from the complex object detector system 1008 may not provide detection results (with the same kind of confidence). In such cases, the still detection process may incorrectly consider the object and its associated tracker as normal (not still). For example, one of the still tracker conditions from above requires detection of a key bounding box in consecutive key frames (e.g., recent key frame bounding boxes are not empty) to consider a tracker as a still tracker. It is highly possible that in such a case, since the complex object detector system 1008 misses the detection of the object in a frame, that the object will no longer be considered as still, which can eventually cause the system to assign a new label to the tracker (and associated object) once the complex object detector system 1008 re-detects the object in a future key frame. A method is needed to resolve the problem when an object was not detected in a key frame while it has been detected in other temporally neighbouring key frames.

A missing key frame detection (MKFD) process is described herein for a tracker that is currently in a key frame. The MKFD process provides a mechanism to mimic a still object (and tracker) in a frame in such cases. If MKFD is successful in any of the steps outlined in the process 1100 shown in FIG. 11, the current object is considered to have been detected by the complex object detector system 1008 in the current frame. In this case, the detection bounding box for the tracker is set to be the previous key bounding box. For example, even though the current key frame did not have a high confidence bounding box detected for the tracker and its object, if MKFD is successful (thus the current tracker should be considered as detected in the current key frame), the high confidence tracker is processed as if it were a still object. For example, when a high confidence tracker is lost, the high confidence tracker is processed in the same way as if it were a still tracker, as shown in FIG. 11. For example, at block 1110, the process 1100 can set the tracker to the normal state and set the current bounding box of the tracker to be the key bounding box. For a high confidence tracker that is not lost, the tracker is processed in the same way as if it were a still tracker, as shown in FIG. 11. For example, at block 1118, the process 1100 can set the current bounding box of the tracker to be the key bounding box. In addition, in either of these two cases (lost or not lost), the key frame bounding box list for the tracker will have the previous key bounding box being used to produce a new entry for addition to the key frame bounding box list.

As previously described, a bounding box refinement process (e.g., BB refinement at block 1120 of process 1100) can be applied in some cases to adjust the final bounding box associated with a high confidence tracker in the current frame. For example, the bounding box refinement process can try to detect whether the current bounding box of a tracker is shrinking too quickly, and if so, instead of the input bounding box being used for the tracker, the previous bounding box of the tracker (bounding box of the previous frame of the tracker) can be used as the final bounding box of the current tracker. In such cases, the input bounding box can be effectively replaced by the previous bounding box.

In one illustrative example, the bounding box refinement process can take a set of three bounding boxes to determine if the current bounding box is shrinking too quickly. The three bounding boxes can include the previous bounding box, the key bounding box (e.g., the bounding box detected for the tracker from the latest key frame), and the current bounding box of the tracker. In some cases, the size of the current bounding box relative to the key bounding box can be determined, which can be used to determine whether to use the previous bounding box or the current bounding box as the final bounding box for the tracker for the current frame. For example, if the size of the current bounding box is less than a first threshold percentage (e.g., denoted as rss) of the size of the key bounding box, the final bounding box for the tracker can be set to the previous bounding box. In another example, if the size of the current bounding box is greater than a second threshold percentage (e.g., denoted as rsb) of the size of the key bounding box, the final bounding box for the tracker can be set to the current bounding box. In some cases, the first and second threshold percentages can be set to the same value. In some cases, the first and second threshold percentages can be set to different values.

In some cases, a spatial relationship between the current bounding box and the previous bounding box, as well as a spatial relationship between the current bounding box and the key bounding box, can be used to determine whether to use the previous bounding box or the current bounding box as the final bounding box for the tracker for the current frame. For example, a first overlapping region between the current bounding box and the key bounding box can be determined. The first overlapping region can be denoted as bbOverlapWithKey and can be defined as currBBnkey BB, with currBB being the current bounding box and key BB being the key bounding box. A second overlapping region between the current bounding box and the previous bounding box can also be determined. The second overlapping region can be denoted as bbOverlapWithPre and can be defined as currBBnpreBB, with preBB being the previous bounding box. The current bounding box can be replaced with the previous bounding box if either one or both of a size of the first overlapping region is less than a first threshold percentage of a size of the key bounding box or a size of the second overlapping region is less than a second threshold percentage of the size of the key bounding box. For instance, in one illustrative example, if size (bbOverlapWithKey) is less than rtk of the size of key BB and/or the size (bbOverlapWithPre) is less than rtp of the size of key BB, the final bounding box of the tracker for the current frame is set to be the previous bounding box. The first threshold percentage (trk) and the second threshold percentage (rtp) can be set to any suitable values. For example, the first threshold percentage (trk) can be set to 0.25, and the second threshold percentage (rtp) can be set to 0.5.

In one illustrative example, the following steps apply to determine whether the current bounding box needs to be modified or set to the previous bounding box:
(a) If the size of the current bounding box is less than rss of that of the key BB, the current bounding box is set to the previous bounding box; terminate the process. Here rss may be set to e.g., 0.125.
(b) If the size of the current bounding box is larger than rsb of that of the key BB, the current bounding box is not changed and the process is terminated.
(c) Denote the overlap bounding boxes bbOverlapWithKey and bbOverlapWithPre as currBB∩key BB and currBB∩preBB (wherein preBB is the previous bounding box), respectively. If size (bbOverlapWithKey) is less than rtk of the size of key BB and size (bbOverlapWithPre) is less than rtp of the size of key BB, bounding box is set to previous bounding box; terminate the process. Here trk and rtp may be set to 0.25 and 0.5 respectively.

Using the above-described object detection and tracking techniques, a hybrid video analytics system can accurately and reliably detect still objects and can provide a stable transition of trackers to the still status. For example, by using the key frame detection results, a slow or still object can be detected for non-key frames and tracking of the object can be performed smoothly so that temporally consistent tracking results are achieved.

As described above, various neural network-based detectors can be used by the complex object detector system 1008. Illustrative examples of deep neural networks include a convolutional neural network (CNN), an autoencoder, a deep belief net (DBN), a Recurrent Neural Networks (RNN), or any other suitable neural network. In one illustrative example, a deep neural network based detector applied by the complex object detector system 1008 can include a deep network based detector, such as a single-shot detector (SSD) (as described below with respect to FIG. 17A-FIG. 17C), a YOLO detector (as described below with respect to FIG. 18A-FIG. 18C), or other suitable detector that operates using a complex neural network.

FIG. 15 is an illustrative example of a deep learning neural network 1500 that can be used by the complex object detector system 1008. An input layer 1520 includes input data. In one illustrative example, the input layer 1520 can include data representing the pixels of an input video frame. The deep learning network 1500 includes multiple hidden layers 1522a, 1522b, through 1522n. The hidden layers 1522a, 1522b, through 1522n include “n” number of hidden layers, where “n” is an integer greater than or equal to one. The number of hidden layers can be made to include as many layers as needed for the given application. The deep learning network 1500 further includes an output layer 1524 that provides an output resulting from the processing performed by the hidden layers 1522a, 1522b, through 1522n. In one illustrative example, the output layer 1524 can provide a classification and/or a localization for an object in an input video frame. The classification can include a class identifying the type of object (e.g., a person, a dog, a cat, or other object) and the localization can include a bounding box indicating the location of the object.

The deep learning network 1500 is a multi-layer neural network of interconnected nodes. Each node can represent a piece of information. Information associated with the nodes is shared among the different layers and each layer retains information as information is processed. In some cases, the deep learning network 1500 can include a feed-forward network, in which case there are no feedback connections where outputs of the network are fed back into itself. In some cases, the network 1500 can include a recurrent neural network, which can have loops that allow information to be carried across nodes while reading in input.

Information can be exchanged between nodes through node-to-node interconnections between the various layers. Nodes of the input layer 1520 can activate a set of nodes in the first hidden layer 1522a. For example, as shown, each of the input nodes of the input layer 1520 is connected to each of the nodes of the first hidden layer 1522a. The nodes of the hidden layer 1522 can transform the information of each input node by applying activation functions to these information. The information derived from the transformation can then be passed to and can activate the nodes of the next hidden layer 1522b, which can perform their own designated functions. Example functions include convolutional, up-sampling, data transformation, and/or any other suitable functions. The output of the hidden layer 1522b can then activate nodes of the next hidden layer, and so on. The output of the last hidden layer 1522n can activate one or more nodes of the output layer 1524, at which an output is provided. In some cases, while nodes (e.g., node 1526) in the deep learning network 1500 are shown as having multiple output lines, a node has a single output and all lines shown as being output from a node represent the same output value.

In some cases, each node or interconnection between nodes can have a weight that is a set of parameters derived from the training of the deep learning network 1500. For example, an interconnection between nodes can represent a piece of information learned about the interconnected nodes. The interconnection can have a tunable numeric weight that can be tuned (e.g., based on a training dataset), allowing the deep learning network 1500 to be adaptive to inputs and able to learn as more and more data is processed.

The deep learning network 1500 is pre-trained to process the features from the data in the input layer 1520 using the different hidden layers 1522a, 1522b, through 1522n in order to provide the output through the output layer 1524. In an example in which the deep learning network 1500 is used to identify objects in images, the network 1500 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the deep neural network 1500 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the network 1500 is trained well enough so that the weights of the layers are accurately tuned.

For the example of identifying objects in images, the forward pass can include passing a training image through the network 1500. The weights are initially randomized before the deep neural network 1500 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the network 1500, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the network 1500 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The deep learning network 1500 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

The deep learning network 1500 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The deep learning network 1500 can include any other deep network other than a CNN, such as an autoencoder, a deep belief nets (DBNs), a Recurrent Neural Networks (RNNs), among others.

FIG. 16 is an illustrative example of a convolutional neural network 1600 (CNN 1600). The input layer 1620 of the CNN 1600 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1622a, an optional non-linear activation layer, a pooling hidden layer 1622b, and fully connected hidden layers 1622c to get an output at the output layer 1624. While only one of each hidden layer is shown in FIG. 16, one of ordinary skill will appreciate that multiple convolutional hidden layers, non-linear layers, pooling hidden layers, and/or fully connected layers can be included in the CNN 1600. As previously described, the output can indicate a single class of an object or can include a probability of classes that best describe the object in the image.

The first layer of the CNN 1600 is the convolutional hidden layer 1622a. The convolutional hidden layer 1622a analyzes the image data of the input layer 1620. Each node of the convolutional hidden layer 1622a is connected to a region of nodes (pixels) of the input image called a receptive field. The convolutional hidden layer 1622a can be considered as one or more filters (each filter corresponding to a different activation or feature map), with each convolutional iteration of a filter being a node or neuron of the convolutional hidden layer 1622a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1622a. Each connection between a node and a receptive field for that node learns a weight and, in some cases, an overall bias such that each node learns to analyze its particular local receptive field in the input image. Each node of the hidden layer 1622a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1622a is due to each node of the convolutional layer being applied to its corresponding receptive field. For example, a filter of the convolutional hidden layer 1622a can begin in the top-left corner of the input image array and can convolve around the input image. As noted above, each convolutional iteration of the filter can be considered a node or neuron of the convolutional hidden layer 1622a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1622a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1622a.

The mapping from the input layer to the convolutional hidden layer 1622a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1622a can include several activation maps in order to identify multiple features in an image. The example shown in FIG. 16 includes three activation maps. Using three activation maps, the convolutional hidden layer 1622a can detect three different kinds of features, with each feature being detectable across the entire image.

In some examples, a non-linear hidden layer can be applied after the convolutional hidden layer 1622a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the network 1600 without affecting the receptive fields of the convolutional hidden layer 1622a.

The pooling hidden layer 1622b can be applied after the convolutional hidden layer 1622a (and after the non-linear hidden layer when used). The pooling hidden layer 1622b is used to simplify the information in the output from the convolutional hidden layer 1622a. For example, the pooling hidden layer 1622b can take each activation map output from the convolutional hidden layer 1622a and generates a condensed activation map (or feature map) using a pooling function. Max-pooling is one example of a function performed by a pooling hidden layer. Other forms of pooling functions be used by the pooling hidden layer 1622a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1622a. In the example shown in FIG. 16, three pooling filters are used for the three activation maps in the convolutional hidden layer 1622a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1622a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1622a having a dimension of 24×24 nodes, the output from the pooling hidden layer 1622b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1600.

The final layer of connections in the network is a fully-connected layer that connects every node from the pooling hidden layer 1622b to every one of the output nodes in the output layer 1624. Using the example above, the input layer includes 28×28 nodes encoding the pixel intensities of the input image, the convolutional hidden layer 1622a includes 3×24×24 hidden feature nodes based on application of a 5×5 local receptive field (for the filters) to three activation maps, and the pooling layer 1622b includes a layer of 3×12×12 hidden feature nodes based on application of max-pooling filter to 2×2 regions across each of the three feature maps. Extending this example, the output layer 1624 can include ten output nodes. In such an example, every node of the 3×12×12 pooling hidden layer 1622b is connected to every node of the output layer 1624.

The fully connected layer 1622c can obtain the output of the previous pooling layer 1622b (which should represent the activation maps of high-level features) and determines the features that most correlate to a particular class. For example, the fully connected layer 1622c layer can determine the high-level features that most strongly correlate to a particular class, and can include weights (nodes) for the high-level features. A product can be computed between the weights of the fully connected layer 1622c and the pooling hidden layer 1622b to obtain probabilities for the different classes. For example, if the CNN 1600 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1624 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

As previously noted, the complex object detector system 1008 can use any suitable neural network based detector. One example includes the SSD detector, which is a fast single-shot object detector that can be applied for multiple object categories or classes. The SSD model uses multi-scale convolutional bounding box outputs attached to multiple feature maps at the top of the neural network. Such a representation allows the SSD to efficiently model diverse box shapes. FIG. 17A includes an image and FIG. 17B and FIG. 17C include diagrams illustrating how an SSD detector (with the VGG deep network base model) operates. For example, SSD matches objects with default boxes of different aspect ratios (shown as dashed rectangles in FIG. 17B and FIG. 17C). Each element of the feature map has a number of default boxes associated with it. Any default box with an intersection-over-union with a ground truth box over a threshold (e.g., 0.4, 0.5, 0.6, or other suitable threshold) is considered a match for the object. For example, two of the 8×8 boxes (shown in blue in FIG. 17B) are matched with the cat, and one of the 4×4 boxes (shown in red in FIG. 17C) is matched with the dog. SSD has multiple features maps, with each feature map being responsible for a different scale of objects, allowing it to identify objects across a large range of scales. For example, the boxes in the 8×8 feature map of FIG. 17B are smaller than the boxes in the 4×4 feature map of FIG. 17C. In one illustrative example, an SSD detector can have six feature maps in total.

For each default box in each cell, the SSD neural network outputs a probability vector of length c, where c is the number of classes, representing the probabilities of the box containing an object of each class. In some cases, a background class is included that indicates that there is no object in the box. The SSD network also outputs (for each default box in each cell) an offset vector with four entries containing the predicted offsets required to make the default box match the underlying object's bounding box. The vectors are given in the format (cx, cy, w, h), with cx indicating the center x, cy indicating the center y, w indicating the width offsets, and h indicating height offsets. The vectors are only meaningful if there actually is an object contained in the default box. For the image shown in FIG. 17A, all probability labels would indicate the background class with the exception of the three matched boxes (two for the cat, one for the dog).

Another deep learning-based detector that can be used by the complex object detector system 1008 to detect or classify objects in images includes the You only look once (YOLO) detector, which is an alternative to the SSD object detection system. FIG. 18A includes an image and FIG. 18B and FIG. 18C include diagrams illustrating how the YOLO detector operates. The YOLO detector can apply a single neural network to a full image. As shown, the YOLO network divides the image into regions and predicts bounding boxes and probabilities for each region. These bounding boxes are weighted by the predicted probabilities. For example, as shown in FIG. 18A, the YOLO detector divides up the image into a grid of 13-by-13 cells. Each of the cells is responsible for predicting five bounding boxes. A confidence score is provided that indicates how certain it is that the predicted bounding box actually encloses an object. This score does not include a classification of the object that might be in the box, but indicates if the shape of the box is suitable. The predicted bounding boxes are shown in FIG. 18B. The boxes with higher confidence scores have thicker borders.

Each cell also predicts a class for each bounding box. For example, a probability distribution over all the possible classes is provided. Any number of classes can be detected, such as a bicycle, a dog, a cat, a person, a car, or other suitable object class. The confidence score for a bounding box and the class prediction are combined into a final score that indicates the probability that that bounding box contains a specific type of object. For example, the yellow box with thick borders on the left side of the image in FIG. 18B is 85% sure it contains the object class “dog.” There are 169 grid cells (13×13) and each cell predicts 5 bounding boxes, resulting in 1845 bounding boxes in total. Many of the bounding boxes will have very low scores, in which case only the boxes with a final score above a threshold (e.g., above a 30% probability, 40% probability, 50% probability, or other suitable threshold) are kept. FIG. 18C shows an image with the final predicted bounding boxes and classes, including a dog, a bicycle, and a car. As shown, from the 1845 total bounding boxes that were generated, only the three bounding boxes shown in FIG. 18C were kept because they had the best final scores.

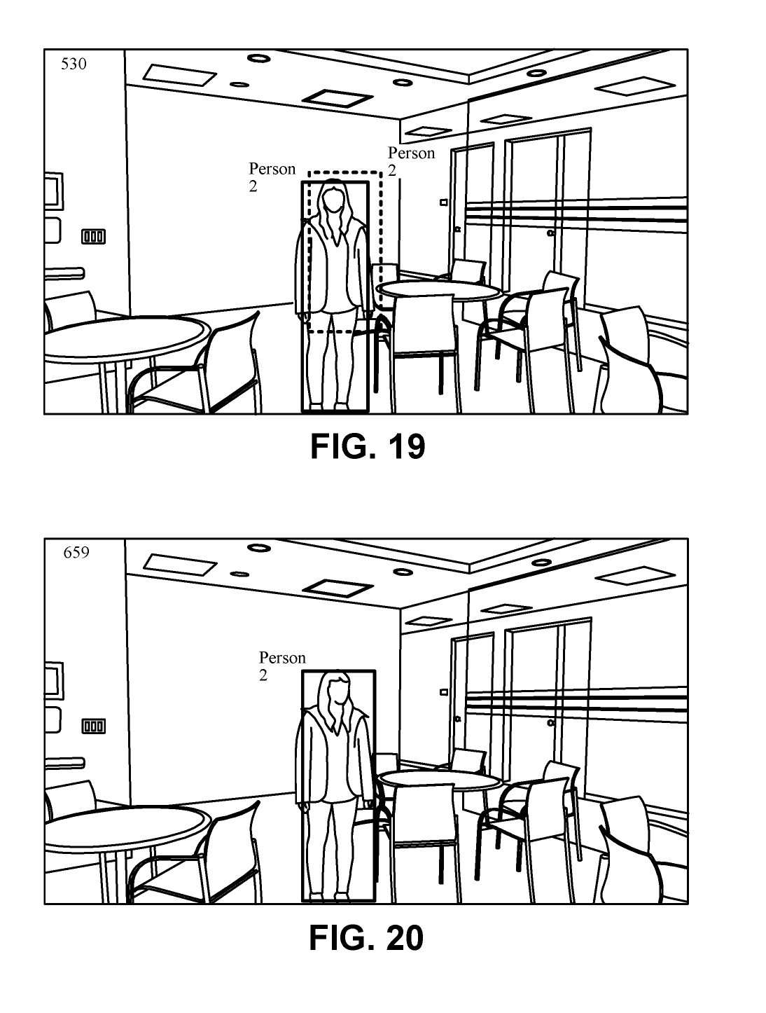

FIG. 19-FIG. 26 are video frames illustrating several subjective examples comparing the still object detection techniques described herein (using a hybrid video analytics system) and a conventional video analytics system that does not use a deep learning based detector. In the examples show in FIG. 19-FIG. 26, the hybrid video analytics solution is based on an SSD detector, and only “person”, “cat”, “dog”, “horse”, and “sheep” are kept; bounding boxes with other classes have been filtered out. In the following subjective examples, the anchor version (shown with dashed bounding boxes) did not handle tracking for slow and still objects. The still object detection techniques described herein (shown with solid bounding boxes) was able to track slow and still objects.

FIG. 19 is a video frame of an environment with a person. Since the person is stopping gradually, the anchor version detected partial human body because of the small blob detected by background subtraction.

FIG. 20 is another video frame of an environment with a person. Since the person is standing still, the anchor version did not detect or track anything (e.g., no blob was detected or tracked) because of the empty blob detected by background subtraction.

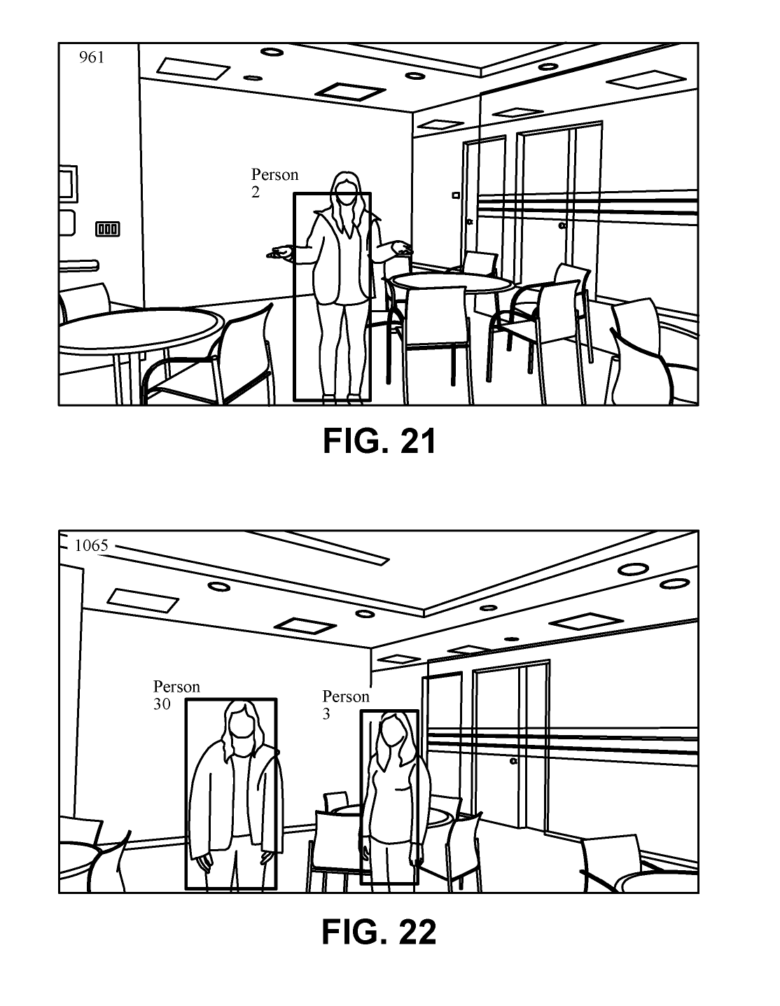

FIG. 21 is another video frame of an environment with a person. Since the person is standing still, the anchor version did not detect anything because of the empty blob detected by background subtraction.

FIG. 22 is another video frame of an environment with two people. Since the two people are standing still, the anchor version did not detect anything because of the empty blob detected by background subtraction.

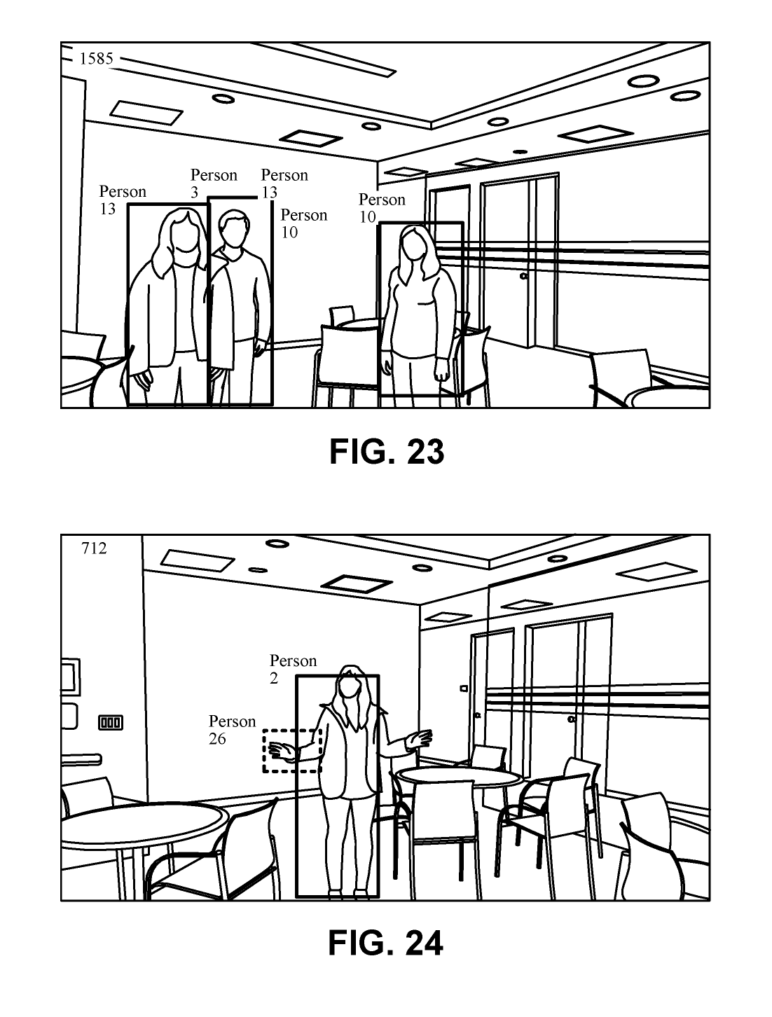

FIG. 23 is a video frame of an environment with three people. Since the three people are standing still, the anchor version did not detect the person with label 10 (the rightmost woman) because of the empty blob detected by background subtraction.

FIG. 24 is a video frame of an environment with a person. The anchor version did not detect the person as a still (or sleeping) object because of the partial body movement, which caused the vanishing process detection to fail.

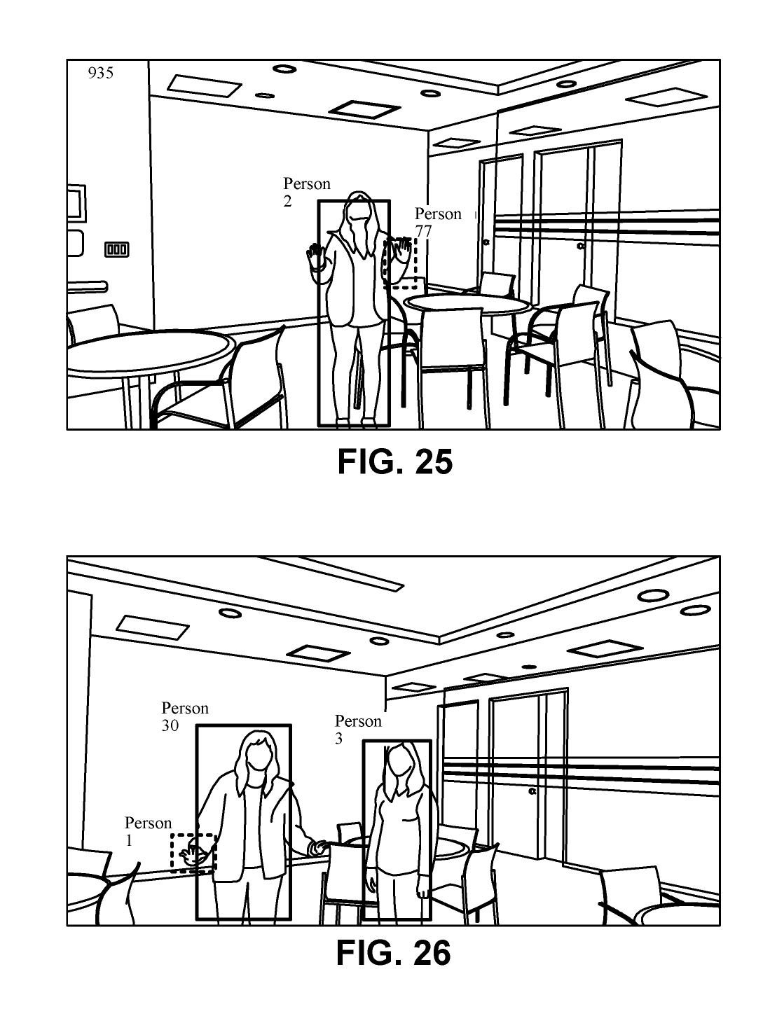

FIG. 25 is another video frame of an environment with a person. The anchor version did not detect the person as a still object because of the partial body movement, which caused the vanishing process detection to fail.

FIG. 26 is a video frame of an environment with two people. The anchor version did not detect the person with label 30 as a still object because of the partial body movement, which caused the vanishing process detection to fail.

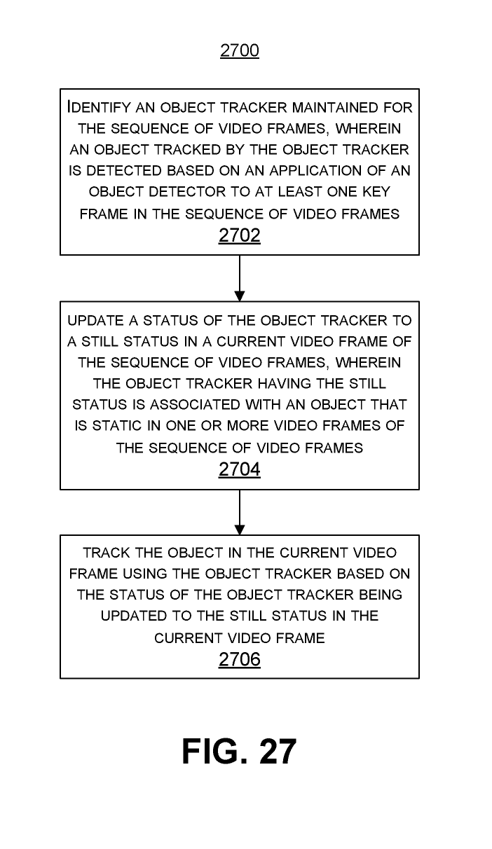

FIG. 27 is a flowchart illustrating an example of a process 2700 of tracking objects in a sequence of video frames using the techniques described herein. At block 2702, the process 2700 includes identifying an object tracker maintained for the sequence of video frames. An object tracked by the object tracker is detected based on an application of an object detector to at least one key frame in the sequence of video frames. The object detector is a complex object detector. As described above, an object detector (e.g., a complex object detector) can be based on a trained classification network. For example, the complex object detector can apply the trained classification network to one or more video frames of the sequence of video frames, such as one or more key frames. As described herein, a key frame is a frame from the sequence of video frames to which the object detector is applied. In some cases, blob detection is performed for each video frame of the sequence of video frames to detect one or more blobs in each video frame, and the object detector is applied only to key frames of the sequence of video frames. The frames that the complex object detector are not applied to are referred to as non-key frames.

At block 2704, the process 2700 includes updating a status of the object tracker to a still status in a current video frame of the sequence of video frames. The object tracker having the still status is associated with an object that is static in one or more video frames of the sequence of video frames. The static object can be completely still, or can be moving slowly in the one or more video frames. For example, it can be determined that the object tracker is a still tracker in the current video frame, the still object tracker being associated with the static object in the one or more video frames. The status of the object tracker can be updated to the still status based on determining the object tracker is a still tracker, as described above.

In some cases, the process 2700 can assign a bounding region to the object tracker for tracking the object in the current video frame. The assigned bounding region is generated by the complex object detector at the at least one key frame. The bounding region can include a bounding box, or any other suitably-shaped bounding region.

In some examples, the process 2700 can include replacing a bounding region of the object tracker in the current frame with a previous bounding region of the object tracker in the at least one key frame based on the status of the object tracker being updated to the still status in the current video frame. In some cases, the previous bounding region is assigned to the object tracker for tracking the object in the current video frame, where the previous bounding region is generated by the object detector when processing the at least one key frame. In some cases, as described above the bounding region of the object tracker in the current frame can be replaced with a previous bounding region of the object tracker in a non-key frame.

In some cases, the process 2700 can include maintaining a key frame bounding region list for the object tracker. The key frame bounding region list includes a plurality of entries, with each entry including a bounding region (e.g., a bounding box) detected by the object detector in a key frame in the sequence of video frames. For example, a first entry in the key frame bounding region list can include a first bounding region, a second entry in the key frame bounding region list can include a second bounding region, a third entry in the key frame bounding region list can include a third bounding region, and so on. In some examples, each entry in the key frame bounding region list further includes a frame difference between the current video frame and the key frame when the bounding region of each entry was detected.

In some examples, updating the status of the object tracker to the still status (and/or determining the object tracker is a still tracker) can be based on a number of entries in the key frame bounding region list (e.g., key frame bounding box list) of the tracker. For example, the process 2700 can include determining that a number of the plurality of entries in the key frame bounding region list includes at least a threshold number of entries. The status of the object tracker is updated to the still status (and/or the object tracker is determined to be a still tracker) based on the number of the plurality of entries including at least the threshold number of entries. For example, as described above, when the number of entries in a key frame bounding box list of a tracker is less than the threshold number of entries, the still detection process can terminate and the current status of the tracker can be set to the S_CONFIRMED_NORMAL status. If the number of entries is more than the threshold number of entries, the still tracker detection process continues for the tracker and/or the object tracker can be considered as a still tracker (e.g., having the still status).

In some aspects, updating the status of the object tracker to the still status (and/or determining the object tracker is a still tracker) can be based on whether any entries in the tracker's key frame bounding region list (e.g., key frame bounding box list) is empty. For example, the process 2700 can determine the plurality of entries in the key frame bounding region list does not include any empty entries. An entry associated with a key frame is set to empty when an object associated with the object tracker is not detected by the object detector in the key frame. The status of the object tracker is updated to the still status (and/or the object tracker is determined to be a still tracker) based on the plurality of entries in the key frame bounding region list not including any empty entries. For example, as described above, when one or more of the key frame bounding boxes in the tracker's key frame bounding box list is determined to be empty (not detected), the still detection process can terminate and the current status of the tracker can be set to the S_CONFIRMED_NORMAL status. In some cases, the current status of the tracker can be set to the S_CONFIRMED_NORMAL status when any of the latest key frame bounding boxes is empty (e.g., the most recent two, three, four, or other suitable number of recent key frames is empty). If none of the relevant key frame bounding boxes from the tracker's key frame bounding box list is empty, the still tracker detection process can continue for the tracker and/or the object tracker can be considered as a still tracker (e.g., having the still status).

In some aspects, updating the status of the object tracker to the still status (and/or determining the object tracker is a still tracker) can be based on a spatial relationship between two key frame bounding boxes in the tracker's key frame bounding region list. For example, the process 2700 can include determining a spatial relationship between two bounding regions from the key frame bounding region list, and determining the spatial relationship is larger than a spatial threshold. The status of the object tracker is updated to the still status (and/or the object tracker can be determined to be a still tracker) based on the spatial relationship being larger than the spatial threshold. In some cases, the two bounding regions from the key frame bounding region list are based on detection performed for two most recent key frames relative to the current video frame in the sequence of video frames. The two most recent key frames can include the last two key frames that occurred in the video sequence before the current video frame. In some cases, determining the spatial relationship includes determining an intersection-over-union between the two bounding regions. For example, as described above, a tracker may be transitioned to have the still status (S_CONFIRMED_STATIC) in the current frame when the spatial relationship between two bounding boxes from the key frame bounding region list is larger than the spatial threshold.

In some aspects, updating the status of the object tracker to the still status (and/or determining the object tracker is a still tracker) can be based on movement of bounding boxes in a key frame distance range. For example, the process 2700 can include determining an amount of movement between a first bounding region and a second bounding region from the plurality of entries of the key frame bounding region list, and determining the amount of movement is less than a movement threshold. The status of the object tracker is updated to the still status (and/or the object tracker can be determined to be a still tracker) based on the amount of movement being less than the movement threshold. In some cases, the amount of movement is determined in a horizontal direction, in a vertical direction, or in the horizontal direction and the vertical direction. For example, as described above, if an amount of movement (e.g., horizontal movement, vertical movement, both horizontal movement and vertical movement, or other movement) is less than a movement threshold, the still tracker detection process can terminate with the current status of the tracker being set to the still status (S_CONFIRMED_STATIC).

At block 2706, the process 2700 includes tracking the object in the current video frame using the object tracker based on the status of the object tracker being updated to the still status (and/or the object tracker being determined to be a still tracker). In some cases, the process 2700 includes determining the object tracked by the object tracker is not detected in the current video frame. In such cases, the object and the object tracker are considered as being lost. Based on the status of the object tracker being updated to the still status (and/or the object tracker being determined to be a still tracker), the object is tracked in the current video frame using the object tracker when the object tracked by the object tracker is not detected in the current video frame. For example, referring to FIG. 11, the process 1100 can determine, at block 1104, that the object tracker is lost. The process 1100 can perform a still check at block 1106 to determine whether the status of the object tracker is a still status (and/or whether the object tracker is a still tracker). The state of the object tracker can then be set to normal (at block 1110) if the status of the object tracker is determined to be a still status (and/or the tracker is a still tracker).

In some cases, the process 2700 includes determining the object tracked by the object tracker is detected in the current video frame. In such cases, the object and the object tracker are considered as not being lost. When the object is detected in the current video frame and when the status of the object tracker is updated to the still status (and/or the object tracker is determined to be a still tracker), the process 2700 can determine that the object tracker includes one or more vanishing bounding regions based on a plurality of bounding regions in a history of bounding regions for the object tracker being constrained by a bounding region generated by the object detector at the at least one key frame. The process 2700 can also track the object in the current video frame using the object tracker based on the status of the object tracker being updated to the still status (and/or the object tracker being determined to be a still tracker) and based on the object tracker being determined to be vanishing. In some examples, the history of bounding regions for the object tracker include bounding regions of the object tracker in video frames between the current video frame and a most recent key frame relative to the current video frame in the sequence of video frames. The most recent key frames can include the last key frame that occurred in the video sequence before the current video frame. For example, referring to FIG. 11, the process 1100 can determine, at block 1104, that the object tracker is not lost, and can perform a still check at block 1106 to determine whether the status of the object tracker is a still status (and/or whether the object tracker is a still tracker). The vanishing check at block 1116 can then be performed at block 1116 if the status of the object tracker is determined to be a still status (and/or the tracker is a still tracker). The state of the object tracker can then be set to normal (at block 1118) if the object tracker is determined to be vanishing.

In some examples, the process 2700 can include identifying an additional object tracker maintained for the sequence of video frames. An additional object tracked by the additional object tracker is detected based on application of the object detector to the at least one key frame. The process 2700 can also include determining that the additional object tracked by the additional object tracker is not detected in the current video frame (and is thus lost), and determining a status of the additional object tracker is not a still status (and/or that the additional object tracker is not a still tracker). The process 2700 can include determining, when the additional object is not detected in the current video frame and when the status of the object tracker is not determined to be the still status (and/or when the additional object tracker is not determined to be a still tracker), the additional object tracker includes one or more vanishing bounding regions based on a plurality of bounding regions in a history of bounding regions for the additional object tracker being constrained by a bounding region generated by the object detector at the at least one key frame. The process 2700 can include tracking the additional object in the current video frame using the additional object tracker when the additional object tracker is determined to be vanishing. For example, referring to FIG. 11, the process 1100 can determine, at block 1104, that the additional object tracker is lost, and can perform a still check at block 1106 to determine whether the additional object tracker is still (e.g., having a still status). If the additional object tracker is determined to not be a still tracker (e.g., does not have the still status), the vanishing check at block 1108 can then be performed to determine whether the additional object tracker is vanishing. The state of the additional object tracker can then be set to normal (at block 1110) if the additional object tracker is determined to be vanishing.

In some examples, the process 2700 can include identifying an additional object tracker maintained for the sequence of video frames. An additional object tracked by the additional object tracker is detected based on application of the object detector to the at least one key frame. The process 2700 can also include determining the additional object tracked by the additional object tracker is detected in the current video frame (and is thus not lost), and determining a status of the additional object tracker is not a still status (and/or that the additional object tracker is not a still tracker). The process 2700 can include applying a bounding region refinement process to a bounding region of the additional object tracker for the current video frame based on the additional object being detected in the current video frame and based on the status of the object tracker is not determined to be the still status (and/or when the additional object tracker not being a still tracker). The process 2700 can include tracking the additional object in the current video frame using the bounding region of the additional object tracker. For example, referring to FIG. 11, the process 1100 can determine, at block 1104, that the additional object tracker is not lost, and can perform a still check at block 1106 to determine whether the additional object tracker is still (e.g., having a still status). If the additional object tracker is determined to not be a still tracker (e.g., does not have the still status), the bounding box refinement process can be applied at block 1120 to adjust the bounding box of the additional object tracker.

In some examples, the bounding region refinement process replaces a current bounding region of the additional object tracker from current video frame with a previous bounding region of the additional object tracker from a previous video frame. In some cases, applying the bounding region refinement process includes obtaining a previous bounding region of the additional object tracker from a previous video frame, a key bounding region generated by the object detector at the at least one key frame, and a current bounding region of the additional object tracker from current video frame. Applying the bounding region refinement process further includes determining that a size of the current bounding region is less than a threshold percentage of a size of the key bounding region. The current bounding region can be replaced with the previous bounding region based on the size of the current bounding region being less than the threshold percentage of the size of the key bounding region.

In some cases, applying the bounding region refinement process includes obtaining a previous bounding region of the additional object tracker from a previous video frame, a key bounding region generated by the object detector at the at least one key frame, and a current bounding region of the additional object tracker from current video frame. Applying the bounding region refinement process further includes determining a first overlapping region between the current bounding region and the key bounding region, and determining a second overlapping region between the current bounding region and the previous bounding region. The current bounding region can be replaced with the previous bounding region based on at least one or more of a size of the first overlapping region being less than a first threshold percentage of a size of the key bounding region or a size of the second overlapping region being less than a second threshold percentage of the size of the key bounding region.

In some examples, the process 2700 includes determining the object tracker is not a false positive tracker based on a history of bounding regions associated with the object tracker, and updating the status of the object tracker to the still status (and/or determining the object tracker is a still tracker) when the object tracker is determined not to be a false positive tracker. In some cases, the history includes bounding regions from each video frame between a frame at which the object tracker was created and a key frame at which the object tracked by the object tracker is detected by the object detector. In such cases, the object tracker is determined not to be a false positive tracker based on the bounding regions in the history being larger than a threshold number of bounding regions. In some cases, the history includes bounding regions from each video frame between the current video frame and a last key frame at which the object tracked by the object tracker is detected by the object detector. In such cases, the object tracker is determined not to be a false positive tracker based on the bounding regions in the history being larger than a threshold number of bounding regions. In some cases, the history includes bounding regions from each video frame between the current video frame and a last key frame at which the object tracked by the object tracker is detected by the object detector. In such cases, the object tracker is determined not to be a false positive tracker based on at least one bounding region in the history being larger than a threshold size of a key bounding region from the last key frame.

In some examples, the process 2700 may be performed by a computing device or an apparatus, such as the video analytics system 1000. In one illustrative example, the process 2700 can be performed by the video analytics system 1000 shown in FIG. 10. In some cases, the computing device or apparatus may include a processor, microprocessor, microcomputer, or other component of a device that is configured to carry out the steps of process 2700. In some examples, the computing device or apparatus may include a camera configured to capture video data (e.g., a video sequence) including video frames. For example, the computing device may include a camera device (e.g., an IP camera or other type of camera device) that may include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. For example, the computing device may include a mobile device with a display (and in some cases a camera, among other components). In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Process 2700 is illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 2700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The video analytics operations discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. An apparatus for tracking objects in a sequence of video frames, comprising:
a memory configured to store one or more video frames of the sequence of video frames; and
a processor coupled to the memory and configured to:
identify an object tracker maintained for the sequence of video frames, wherein an object tracked by the object tracker is detected based on an application of an object detector to at least one key frame in the sequence of video frames;
update a status of the object tracker to a still status in a current video frame of the sequence of video frames, wherein the object tracker having the still status is associated with an object that is static in one or more video frames of the sequence of video frames; and
track the object in the current video frame using the object tracker based on the status of the object tracker being updated to the still status in the current video frame.

2. The apparatus of claim 1, wherein the processor is further configured to replace a bounding region of the object tracker in the current frame with a previous bounding region of the object tracker in the at least one key frame based on the status of the object tracker being updated to the still status in the current video frame.

3. The apparatus of claim 2, wherein the previous bounding region is assigned to the object tracker for tracking the object in the current video frame, and wherein the previous bounding region is generated by the object detector when processing the at least one key frame.

4. The apparatus of claim 1, wherein a key frame is a frame from the sequence of video frames to which the object detector is applied.

5. The apparatus of claim 1, wherein blob detection is performed for each video frame of the sequence of video frames to detect one or more blobs in each video frame, and wherein the object detector is applied only to key frames of the sequence of video frames.

6. The apparatus of claim 1, wherein the processor is further configured to maintain a key frame bounding region list for the object tracker, the key frame bounding region list including a plurality of entries, wherein each entry in the key frame bounding region list includes a bounding region detected by the object detector in a key frame in the sequence of video frames.

7. The apparatus of claim 6, wherein each entry in the key frame bounding region list further includes a frame difference between the current video frame and the key frame when the bounding region of each entry was detected.

8. The apparatus of claim 6, wherein updating the status of the object tracker to the still status includes:
determining a number of the plurality of entries in the key frame bounding region list includes at least a threshold number of entries; and
updating the status of the object tracker to the still status based on the number of the plurality of entries including at least the threshold number of entries.

9. The apparatus of claim 6, wherein updating the status of the object tracker to the still status includes:
determining a spatial relationship between two bounding regions from the key frame bounding region list;
determining the spatial relationship is larger than a spatial threshold; and
updating the status of the object tracker to the still status based on the spatial relationship being larger than the spatial threshold.

10. The apparatus of claim 9, wherein the two bounding regions from the key frame bounding region list are based on detection performed for two most recent key frames to the current video frame in the sequence of video frames.

11. The apparatus of claim 6, wherein updating the status of the object tracker to the still status includes:
determining an amount of movement between a first bounding region and a second bounding region from the plurality of entries of the key frame bounding region list;
determining the amount of movement is less than a movement threshold; and
updating the status of the object tracker to the still status based on the amount of movement being less than the movement threshold.

12. The apparatus of claim 1, wherein the processor is further configured to determine the object tracked by the object tracker is not detected in the current video frame, and wherein, based on the status of the object tracker being updated to the still status, the object is tracked in the current video frame using the object tracker when the object tracked by the object tracker is not detected in the current video frame.

13. The apparatus of claim 1, wherein the processor is further configured to:
determine the object tracked by the object tracker is detected in the current video frame;
determine, when the object is detected in the current video frame and when the status of the object tracker is updated to the still status, the object tracker includes one or more vanishing bounding regions based on a plurality of bounding regions in a history of bounding regions for the object tracker being constrained by a bounding region generated by the object detector at the at least one key frame; and
track the object in the current video frame using the object tracker based on the status of the object tracker being updated to the still status and based on the object tracker being determined to be vanishing.

14. The apparatus of claim 13, wherein the history of bounding regions for the object tracker include bounding regions of the object tracker in video frames between the current video frame and a most recent key frame to the current video frame in the sequence of video frames.

15. The apparatus of claim 1, wherein the processor is further configured to:
determine the object tracker is not a false positive tracker based on a history of bounding regions associated with the object tracker; and
update the status of the object tracker to the still status when the object tracker is determined not to be a false positive tracker.

16. The apparatus of claim 1, wherein the object detector is based on a trained classification network.

17. The apparatus of claim 1, further comprising at least one of a camera configured to capture sequence of video frames and a display configured to display one or more video frames of the sequence of video frames.

18. A method of tracking objects in a sequence of video frames, the method comprising:
identifying an object tracker maintained for the sequence of video frames, wherein an object tracked by the object tracker is detected based on an application of an object detector to at least one key frame in the sequence of video frames;
update a status of the object tracker to a still status in a current video frame of the sequence of video frames, wherein the object tracker having the still status is associated with an object that is static in one or more video frames of the sequence of video frames; and
tracking the object in the current video frame using the object tracker based on the status of the object tracker being updated to the still status in the current video frame.

19. The method of claim 18, further comprising replacing a bounding region of the object tracker in the current frame with a previous bounding region of the object tracker in the at least one key frame based on the status of the object tracker being updated to the still status in the current video frame.

20. The method of claim 19, wherein the previous bounding region is assigned to the object tracker for tracking the object in the current video frame, and wherein the previous bounding region is generated by the object detector when processing the at least one key frame.

21. The method of claim 18, wherein a key frame is a frame from the sequence of video frames to which the object detector is applied.

22. The method of claim 18, wherein blob detection is performed for each video frame of the sequence of video frames to detect one or more blobs in each video frame, and wherein the object detector is applied only to key frames of the sequence of video frames.

23. The method of claim 18, further comprising maintaining a key frame bounding region list for the object tracker, the key frame bounding region list including a plurality of entries, wherein each entry in the key frame bounding region list includes a bounding region detected by the object detector in a key frame in the sequence of video frames.

24. The method of claim 23, wherein each entry in the key frame bounding region list further includes a frame difference between the current video frame and the key frame when the bounding region of each entry was detected.

25. The method of claim 23, wherein updating the status of the object tracker to the still status includes:
determining a number of the plurality of entries in the key frame bounding region list includes at least a threshold number of entries; and
updating the status of the object tracker to the still status based on the number of the plurality of entries including at least the threshold number of entries.

26. The method of claim 23, wherein updating the status of the object tracker to the still status includes:
determining a spatial relationship between two bounding regions from the key frame bounding region list;
determining the spatial relationship is larger than a spatial threshold; and
updating the status of the object tracker to the still status based on the spatial relationship being larger than the spatial threshold.

27. The method of claim 26, wherein the two bounding regions from the key frame bounding region list are based on detection performed for two most recent key frames to the current video frame in the sequence of video frames.

28. The method of claim 23, wherein updating the status of the object tracker to the still status includes:
determining an amount of movement between a first bounding region and a second bounding region from the plurality of entries of the key frame bounding region list;
determining the amount of movement is less than a movement threshold; and
updating the status of the object tracker to the still status based on the amount of movement being less than the movement threshold.

29. The method of claim 18, further comprising determining the object tracked by the object tracker is not detected in the current video frame, and wherein, based on the status of the object tracker being updated to the still status, the object is tracked in the current video frame using the object tracker when the object tracked by the object tracker is not detected in the current video frame.

30. The method of claim 18, further comprising:
determining the object tracked by the object tracker is detected in the current video frame;
determining, when the object is detected in the current video frame and when the status of the object tracker is updated to the still status, the object tracker includes one or more vanishing bounding regions based on a plurality of bounding regions in a history of bounding regions for the object tracker being constrained by a bounding region generated by the object detector at the at least one key frame; and
tracking the object in the current video frame using the object tracker based on the status of the object tracker being updated to the still status and based on the object tracker being determined to be vanishing.
